(19) United States
(12) Patent Application Publication
(10) Pub. No.: US 2025/0240599 A1
(43) Pub. Date: Jul. 24, 2025

(54) LOCALIZATION AND FINGERPRINTING FOR BLIND ZONE DETECTION

(71) Applicant: Samsung Electronics Co., Ltd., Suwon-si (KR)

(72) Inventors: Rebal Jurdi, Allen, TX (US); Yuda Feng, Plano, TX (US); Guanbo Chen, McKinney, TX (US); Yuming Zhu, Plano, TX (US)

(21) Appl. No.: 19/015,500

(22) Filed: Jan. 9, 2025

Related U.S. Application Data
(60) Provisional application No. 63/622,910, filed on Jan. 19, 2024.

(51) Int. Cl. H04W 4/021; H04W 4/02

(52) U.S. Cl. CPC H04W 4/021; H04W 4/023

(57) ABSTRACT

A station (STA) in a wireless network. The STA is configured to cause receiving, from a target STA, information associated with a first anchor point (AP) and model training; transmitting, to the first AP, a first request that first AP perform a first ranging with two or more other APs; receiving, from first AP, first ranging data that include location information for first AP; determining a location of first AP based on the first ranging data; training a first model based on the information associated with model training and the location of first AP; transmitting, to first AP, a second request that first AP perform a second ranging with target STA; receiving, from first AP, second ranging data including movement information of target STA; and determining a first predicted position for target STA based on the second ranging data and the trained first model.

### CROSS REFERENCE TO RELATED APPLICATION

This application claims benefit of U.S. Provisional Application No. 63/622,910, entitled “Localization and Fingerprinting for Blind Zone Detection,” filed on Jan. 19, 2024, in the United States Patent and Trademark Office, the entire contents of which are hereby incorporated by reference.

### TECHNICAL FIELD

This disclosure relates generally to a wireless communication system, and more particularly to, for example, but not limited to, indoor positioning in wireless communication systems.

### BACKGROUND

Over the past decade, indoor positioning has surged in popularity, driven by the increasing number of personal wireless devices and the expansion of wireless infrastructure. Various indoor positioning applications have emerged, spanning smart homes, buildings, surveillance, disaster management, industry, and healthcare, all demanding broad availability and precise accuracy. However, traditional positioning methods often suffer from limitations such as inaccuracy, impracticality, and scarcity. Ultra-wideband (UWB) technology has been adopted for indoor positioning. While UWB offers great accuracy, it lacks widespread adoption of UWB devices for use as ranging anchor points, unlike Wi-Fi, which is ubiquitous in commercial and residential environments. With Wi-Fi access points and stations pervading most spaces, indoor positioning using Wi-Fi has emerged as a preferred solution.

The description set forth in the background section should not be assumed to be prior art merely because it is set forth in the background section. The background section may describe aspects or embodiments of the present disclosure.

### SUMMARY

An aspect of the disclosure provides a station (STA) in a wireless network. The STA comprises a memory and a processor. The processor is coupled to the memory. The processor is configured to cause receiving, from a target STA, information associated with a first anchor point (AP) and location identification model training. The processor is further configured to cause transmitting, to the first AP, a first request that the first AP perform a first ranging with two or more other APs. The processor is further configured to cause receiving, from the first AP, first ranging data that include location information for the first AP in response to the first request. The processor is further configured to cause determining a location of the first AP based on the first ranging data. The processor is further configured to cause training a first location identification model based on the information associated with location identification model training and the location of the first AP. The processor is further configured to cause transmitting, to the first AP, a second request that the first AP perform a second ranging with the target STA. The processor is further configured to cause receiving, from the first AP, second ranging data that include first movement information of the target STA in response to the second request. The processor is further configured to cause determining a first predicted position for the target STA based on the second ranging data and the trained first location identification model.

In an embodiment, the processor is further configured to cause receiving, from the target STA, information associated with a second AP. The processor is further configured to cause transmitting, to the first AP and the second AP, the first request that the first AP and the second AP perform the first ranging with one another and one or more other APs. The processor is further configured to cause receiving, from the first AP and the second AP, the first ranging data that include location information for the first AP and the second AP in response to the first request. The processor is further configured to cause determining the location of the first AP and a location of the second AP based on the first ranging data. The processor is further configured to cause transmitting, to the first AP and the second AP, the second request that the first AP and the second AP perform the second ranging with the target STA. The processor is further configured to cause receiving, from the first AP and the second AP, the second ranging data that includes the first movement information of the target STA in response to the second request.

In an embodiment, the processor is further configured cause to transmitting, to the first AP, a third request that the first AP perform a third ranging. The processor is further configured to cause receiving, from the first AP, third ranging data that includes second movement information of the target STA in response to the third request. The processor is further configured to cause determining a second predicted position for the target STA based on the third ranging data and the trained first location identification model.

In an embodiment, the training the first location identification model comprises transmitting, to the target STA, a third request that the target STA move around in a first zone. The training the first location identification model further comprises receiving, from the target STA, first sensory data that includes third movement information of the target STA's movement in response to the third request. The training the first location identification model further comprises transmitting, to the first AP, a fourth request that the first AP perform a third ranging with the target STA during the STA's movement in the first zone. The training the first location identification model further comprises receiving, from the first AP, third ranging data that includes second movement information of the target STA's movement in response to the third request. The training the first location identification model further comprises updating the first location identification model based on the third ranging data, the first sensory data and the first zone.

In an embodiment, the training the first location identification model further comprises tracking a first trajectory of the movement of the target STA inside the first zone based on an initial position of the target STA inside the first zone, the third ranging data and the first sensory data. The training the first location identification model further comprises generating a first zone signature based on the first trajectory, wherein the first zone signature characterizes one or more predicted positions in the first zone.

In an embodiment, the processor is further configured to cause transmitting, to the first AP, the second request that the first AP perform the second ranging with the target STA for a period of time. The processor is further configured to cause determining the first predicted position for the target STA based on the second ranging data and the trained first location identification model. The processor is further configured to cause determining if the first predicted position is characterized by the first zone signature. The processor is further configured to cause determining if the first predicted position belongs to the first zone signature based on information associated with the first zone signature and information associated with a second zone signature. The second zone signature characterizes the first predicted position in a second zone. The processor is further configured to cause updating the trained first location identification model based on the first predicted position belonging to the first zone signature.

In an embodiment, the tracking further comprises transmitting, to the first AP, the second request that the AP perform the second ranging with the target STA for a period of time or the fourth request that the first AP perform the third ranging with the target STA. The tracking further comprises receiving, from the first AP, the second ranging data or the third ranging data based on the movement of the target STA during a first sub-period of time. The tracking further comprises determining a first predicted intersection position based on the location of the first AP and a location of a second AP. The tracking further comprises determining a first residual of the first predicted intersection position based on trilateration. The tracking further comprises initializing a first track filter based on the first intersection position, wherein the first residual is less than a second residual of a second intersection position. The first track filter is used to track the first trajectory of the movement of the target STA in the first zone.

In an embodiment, the training the first location identification model further comprises updating a first classifier based on the third ranging data and the first sensory data. The first classifier characterizes one or more predicted positions to belong to the first zone. The first classifier indicates if the first predicted position belongs to the first zone.

In an embodiment, the processor is further configured to cause transmitting, to the first AP, the second request that the first AP perform the second ranging with the target STA. The processor is further configured to cause receiving, from the first AP, second ranging data that include first movement information of the target STA in response to the second request. The processor is further configured to cause determining the first predicted position for the target STA based on the second ranging data and the first location identification model.

In an embodiment, the processor is further configured to cause transmitting, to the target STA, a fifth request for information indicating if the first zone needs to be updated or a second zone needs to be updated. The processor is further configured to cause receiving, from the target STA, a first response indicating that the first zone needs to be updated or the second zone needs to be updated. The processor is further configured to cause updating the first zone or the second zone based on the information associated with location identification model training and the location of the first AP.

In an embodiment, the processor is further configured to cause determining information associated with a first AP and location identification model training. The processor is further configured to cause transmitting, to the first AP, the first request that the first AP perform a first ranging with two or more other APs. The processor is further configured to cause receiving, from the first AP, the first ranging data that includes location information for the first AP in response to the first request. The processor is further configured to cause determining a location of the first AP based on the first ranging data. The processor is further configured to cause training a first location identification model based on the information associated with location identification model training and the location of the first AP. The processor is further configured to cause transmitting, to the first AP, the second request that the first AP perform a second ranging with the STA. The processor is further configured to cause receiving, from the first AP, second ranging data that includes the first movement information of the STA in response to the second request. The processor is further configured to cause determining a first predicted position for the STA based on the second ranging data and the trained first location identification model.

An aspect of the disclosure provides a station (STA) in a wireless network. The STA comprises a memory and a processor. The processor is coupled to the memory. The processor is configured to cause determining information associated with a first anchor point (AP) and location identification model training. The processor is further configured to cause transmitting, to a locator STA, a first request for a first predicted position of the STA, and the information associated with the first AP and location identification model training. The processor is further configured to cause receiving, from the locator STA, a second request that the STA move in a first zone based on the information associated with location identification model training. The processor is further configured to cause moving in the first zone based on the second request in response to the second request. The processor is further configured to cause receiving, from the locator STA, the first predicted position of the STA in response to the first request.

In an embodiment, the processor is further configured to cause determining information associated with a second AP. The processor is further configured to cause transmitting, to the locator STA, the first request including information associated with the second AP.

In an embodiment, the processor is further configured to cause receiving, from the locator STA, a third request for information indicating if the first zone needs to be updated. The processor is further configured to cause transmitting, to the locator STA, a second response including information indicating that the first zone needs to be updated. The processor is further configured to cause receiving, from the locator STA, a fourth request that the STA move in the first zone based on the information associated with location identification model training. The processor is further configured to cause moving in the first zone based on the information associated with location identification model training in response to the fourth request.

An aspect of the disclosure provides a method performed by a station (STA). The method comprises receiving, from a target STA, information associated with a first anchor point (AP) and location identification model training. The method further comprises transmitting, to the first AP, a first request that the first AP perform a first ranging with two or more other APs. The method further comprises receiving, from the first AP, first ranging data that include location information for the first AP in response to the first request. The method further comprises determining a location of the first AP based on the first ranging data. The method further comprises training a first location identification model based on the information associated with location identification model training and the location of the first AP. The method further comprises transmitting, to the first AP, a second request that the first AP perform a second ranging with the target STA. The method further comprises receiving, from the first AP, second ranging data that include first movement information of the target STA in response to the second request. The method further comprising determining a first predicted position for the target STA based on the second ranging data and the trained first location identification model.

In an embodiment, the method further comprises receiving, from the target STA, information associated with a second AP. The method further comprises transmitting, to the first AP and the second AP, the first request that the first AP and the second AP perform the first ranging with one another and one or more other APs. The method further comprises receiving, from the first AP and the second AP, the first ranging data that include location information for the first AP and the second AP in response to the first request. The method further comprises determining the location of the first AP and a location of the second AP based on the first ranging data. The method further comprises transmitting, to the first AP and the second AP, the second request that the first AP and the second AP perform the second ranging with the target STA. The method further comprises receiving, from the first AP and the second AP, the second ranging data that includes the first movement information of the target STA in response to the second request.

In an embodiment, the method further comprises transmitting, to the first AP, a third request that the first AP perform a third ranging. The method further comprises receiving, from the first AP, third ranging data that includes second movement information of the target STA in response to the third request. The method further comprises determining a second predicted position for the target STA based on the third ranging data and the trained first location identification model.

In an embodiment, the training the first location identification model comprises transmitting, to the target STA, a third request that the target STA move around in a first zone. The training the first location identification model further comprises receiving, from the target STA, first sensory data that includes third movement information of the target STA's movement in response to the third request. The training the first location identification model further comprises transmitting, to the first AP, a fourth request that the first AP perform a third ranging with the target STA during the STA's movement in the first zone. The training the first location identification model further comprises receiving, from the first AP, third ranging data that includes second movement information of the target STA's movement in response to the third request. The training the first location identification model further comprises updating the first location identification model based on the third ranging data, the first sensory data and the first zone.

In an embodiment, the training the first location identification model further comprises tracking a first trajectory of the movement of the target STA inside the first zone based on an initial position of the target STA inside the first zone, the third ranging data and the first sensory data. The training the first location identification model further comprises generating a first zone signature based on the first trajectory, wherein the first zone signature characterizes one or more predicted positions in the first zone.

In an embodiment, the method further comprises transmitting, to the target STA, a fifth request for information indicating if the first zone needs to be updated or a second zone needs to be updated. The method further comprises receiving, from the target STA, a first response indicating that the first zone needs to be updated or the second zone needs to be updated. The method further comprises updating the first zone or the second zone based on the information associated with location identification model training and the location of the first AP.

Device-based zone identification provides for indoor positioning which permits controlling smart home features, tracking of assets endowed with wireless transceivers within buildings and emergency response finding individuals within a building or warehouse down to the room/zone level aiding in rescue efforts.

### BRIEF DESCRIPTION OF THE DRAWINGS

FIG. 1 shows an example of a wireless network in accordance with an embodiment.

FIG. 2A shows an example of access point (AP) in accordance with an embodiment.

FIG. 2B shows an example of station (STA) in accordance with an embodiment.

FIG. 3 shows an example scenario depicting necessary signaling to compute the time of flight (ToF) in accordance with an embodiment.

FIG. 4 shows an example scenario depicting necessary signaling to compute round-trip time (RTT) in accordance with an embodiment.

FIG. 5 shows an example scenario depicting necessary signaling to compute time difference of arrival (TDoA) by a STA needing to know the STA's location in accordance with an embodiment.

FIG. 6 shows an example scenario depicting the necessary signaling to compute the TDoA by a set of collaborating APs needing to estimate the position of a STA interested in accordance with an embodiment.

FIG. 7 shows an example scenario depicting obtaining distance by inverting the signal strength (RSSI) in accordance with an embodiment.

FIG. 8 shows an example scenario depicting a targeted premises with rooms comprising five different zones in accordance with an embodiment.

FIG. 9 shows an example scenario depicting a fine timing measurement (FTM) session in accordance with an embodiment in accordance with an embodiment.

FIG. 10 shows an example scenario depicting trilateration in accordance with an embodiment.

FIG. 11A shows an example scenario depicting orthogonal transformation using rotation and reflection in accordance with an embodiment.

FIG. 11B shows an example scenario depicting orthogonal transformation using rotation in accordance with an embodiment.

FIG. 12 shows a flowchart demonstrating the four phases of zone prediction in accordance with an embodiment of this disclosure in accordance with an embodiment.

FIG. 13 shows a flowchart demonstrating the operations of a user STA corresponding to the Setup Phase of the Training Phase in accordance with an embodiment.

FIG. 14 shows an example scenario of a user STA performing the training phase on a premises featuring five selected zones in accordance with an embodiment.

FIG. 15 shows an example scenario of a user STA performing the training stage using autolocalization in accordance with an embodiment.

FIG. 16 shows an example scenario depicting a premises featuring five zones, a row of four rooms and a hallway in accordance with an embodiment.

FIG. 17 shows an example scenario depicting the determination of zones by auto-localization featuring four APs in accordance with an embodiment.

FIG. 18 shows another example scenario depicting the determination of zones by auto-localization featuring four APs in accordance with an embodiment.

FIG. 19 shows an example scenario depicting supervised training of classifiers in accordance with an embodiment.

FIG. 20 shows a flowchart demonstrating the operations of a user STA corresponding to the training phase in accordance with an embodiment.

FIG. 21 shows operations of a user STA in utilizing a positioning algorithm in predicting a device's position in accordance with an embodiment.

FIG. 22 shows an example scenario of a premises comprised of four zones in accordance with an embodiment.

FIG. 23 shows the operation of a user STA performing a model inference in accordance with an embodiment.

FIG. 24 shows a flowchart of the operations of a user STA corresponding to the inference phase in accordance with an embodiment.

FIG. 25 shows a flowchart of the inputs and operations of a user STA corresponding to the process for amending zones in accordance with an embodiment.

FIG. 26 shows a flowchart of the operations of a user STA corresponding to initialization and re-initialization of a positioning algorithm in accordance with an embodiment.

FIG. 27 shows a flowchart of the operations of a user STA in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

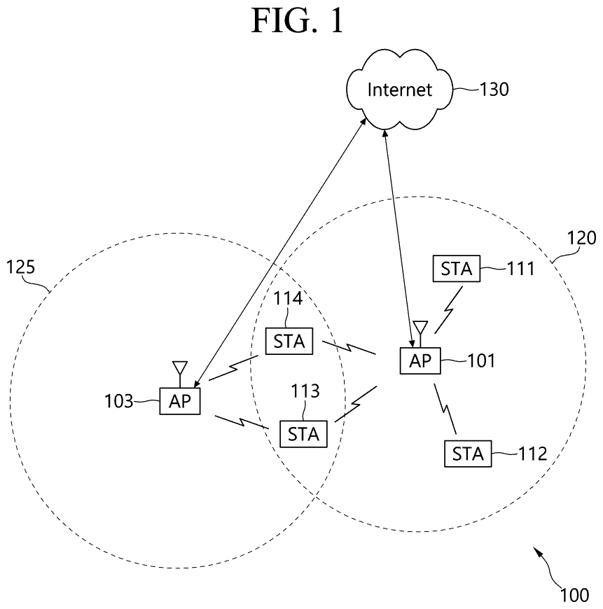

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

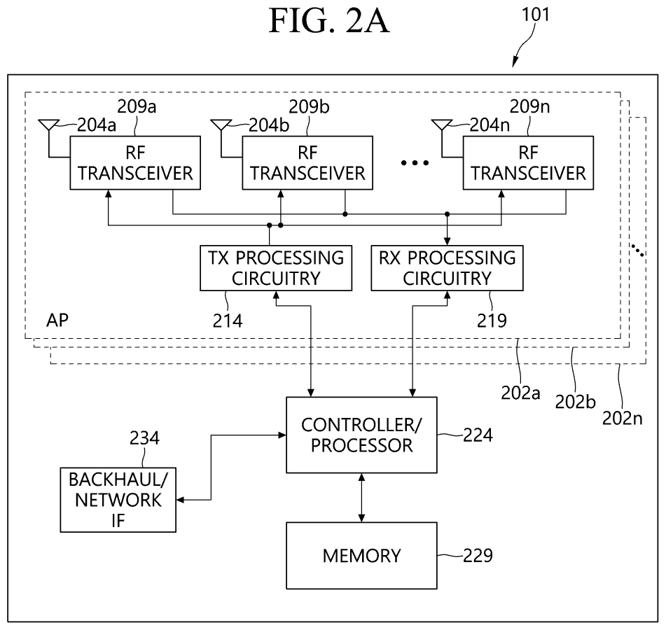

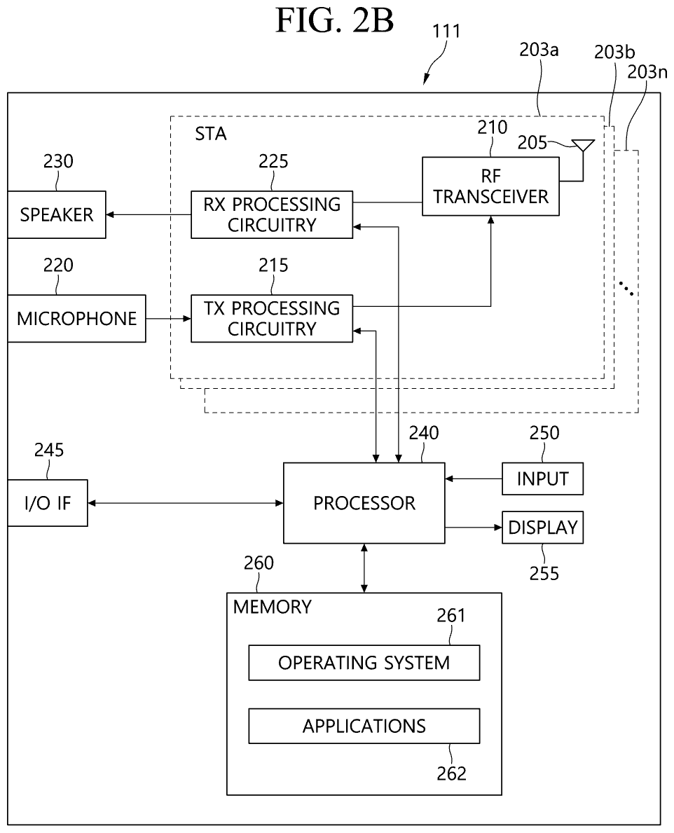

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

The following documents are hereby incorporated by reference in their entirety into the present disclosure as if fully set forth herein: i) D1 (U.S. Pat. No. 12,044,790 B2), June 2023, and ii) D2 (WO 2009-105991 A1), February 2009.

In this disclosure, devices and stations (STAs) may be used interchangeably to refer to the target device for which measurements are being determined. Similarly, access points and anchor points (APs) may be used interchangeably to refer to the devices used to gather measurements based on the target device.

Indoor positioning, or indoor localization, has grown in popularity over the last decade in parallel with the growth in the number of personal wireless devices as well as wireless infrastructure. While the use cases are plenty and include smart homes and buildings, surveillance, disaster management, industry and healthcare, they all require wide availability and good accuracy. Indoor positioning may either be device based or device free. Device-based positioning refers to the case where the position of the user is inferred from the position of a device on the user, specifically from information collected by the user's device. Device-free positioning, however, uses wireless sensing technologies, such as motion or presence detection technologies. Device-based positioning, with which this disclosure is concerned, falls within one of four broad categories: 1) position fixing, 2) fingerprinting, 3) dead reckoning, and 4) hybrid methods.

The first category is position fixing, a term borrowed from satellite navigation. The position of an object is determined as the solution of an optimization problem, the inputs of which include range measurements, or distance measurements, between the object and a number of anchor points (APs) with known locations. Source of range information, regardless of the underlying wireless technology, WiFi, Bluetooth, ultra-wideband (UWB), or other, include received signal strength (RSSI), time of flight (ToF), round-trip time (RTT), and time difference of arrival (TDoA). Non-wireless ranging technologies include optical laser ranging.

The second category is the fingerprinting-based method. The fingerprinting-based method follows a two-stage process. In the first stage, known as the training stage, a spatial database is constructed mapping position identifiers, such as room, to features such as range measurements, including received signal strength, such as RSSI in WiFi or Bluetooth, and RTT, and sensor information, such as magnetic field, pressure, and light. In the second and final stage, known as the operating stage, the database is queried online using collected features and the position is looked up and returned.

The third category is the pedestrian dead reckoning (PDR) or sensor-based method. In this category, the positioning is estimated through accumulating incremental displacements on top of a known initial position. The displacement may be computed by continuously sampling sensors, such as an inertial measurement unit (IMU) including magnetometer, accelerometer, and gyroscope.

The fourth category is a combination of aforementioned methods which is commonly known as sensor fusion or range-and-sensor-based methods. Positioning is first estimated from sensor readings through PDR and then updated through fusion with range measurements.

### Position Fixing

In position fixing, the time of flight (ToF) is determined by one device, typically an anchor point (AP), transmitting a message to the target device, for example a station (STA), embedding the timestamp t₁ at which the message was sent. The target STA receives the message, decodes it, timestamps its reception at t₂, and determines the ToF and corresponding STA-AP distance as shown in Equation 1.

$$r = x * ( {t}_{1} - {t}_{2} ) \qquad Equation 1$$

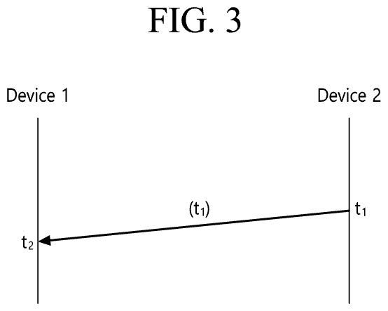

FIG. 3 shows an example scenario depicting necessary signaling to compute the ToF in accordance with an embodiment. The example depicted in FIG. 3 is for explanatory and illustration purposes. FIG. 3 does not limit the scope of this disclosure to any particular implementation.

Referring to FIG. 3, Device 1 and Device 2 are STAs. Device 2 transmits a message to Device 1 at t₁. The message comprises t₁, in addition to its other contents. Device 1 receives the message from Device 2 at t₂.

Trilateration is a standard method in range-based positioning. In trilateration, the target STA measures its distance from at least 3 APs to estimate its two-dimensional position. The target STA determines its position as the intersection of 3 or more circles centered around the APs. The radius of the circles may be the corresponding STA-AP distance. Where there are more than 3 APs, the method is known as multi-lateration. Other methods for determining position from range measurements exist. For example, Bayesian filtering, also known as the Kalman filter, is a more sophisticated method for determining from range measurements. The ranging mechanism to compute time of flight computation is standardized by UWB in IEEE 802.15.4z as one-way ranging (OWR).

In position fixing, the round-trip time (RTT) is determined by one device, typically the target STA, transmitting an empty message to an AP and timestamps the transmission time t₁. The AP receives the message, timestamps the reception time t₂, transmits a message to the target STA in response. The AP timestamps the transmission time as t₃ and embeds the t₂ and t₃ in the message. Subsequently, the target STA receives the message embedded with t₂ and t₃, timestamps the reception time t₄, and decodes the two timestamps. The target STA determines the round-trip time based on t₁, t₂, t₃, t₄ and the STA-AP distance as shown in Equation 2.

$$r = c * ( {t}_{4} - {t}_{1} - {t}_{3} + {t}_{2} ) / 2 \qquad Equation 2$$

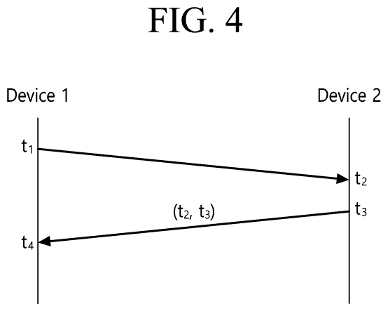

FIG. 4 shows an example scenario depicting necessary signaling to compute RTT in accordance with an embodiment. The example depicted in FIG. 4 is for explanatory and illustration purposes. FIG. 4 does not limit the scope of this disclosure to any particular implementation.

Referring FIG. 4, Device 1 and Device 2 are STAs. Device 1 transmits a first message to Device 2 at t₁. Device 2 receives the first message at t₂. Subsequently, Device 2 transmits a second message to Device 1 at t₃. The message comprises t₂ and t₃. Device 1 receives the second message at t₄.

In addition to the operations discussed above for the method for determining two-dimensional position of the target STA, RTT may be used to determine the STA-AP distance instead of ToF. This mechanism is standard in UWB under IEEE 802.15.4z, known is two-way ranging (TWR), and in WiFi under IEEE 802.11mc, known as fine timing measurement (FTM). The time difference of arrival (TDoA) may be determined for uplink or downlink.

Downlink TDoA is determined by monitoring for the ranging between different pairs of anchor points to estimate the difference in the STA-AP distances. The difference may be determined by an initiating AP and a responding AP ranging with one another using the two-way ranging method explained above. The target STA timestamps the time t₂ at which it observes the message while monitoring for the message transmitted by the initiating AP and decodes the timestamp t₁ at which the message was sent. The target STA also timestamps the time t₄ at which it observes the message while monitoring for the message transmitted by the responding AP to the initiating AP and decodes the timestamp t₃ at which the response was sent. The target STA then determines the difference in the distances from the initiating AP and the responding AP as shown in Equation 3.

$$Δ r = c \cdot ( {t}_{4} - {t}_{2} ) - c \cdot ( {t}_{3} - {t}_{1} ) \qquad Equation 3$$

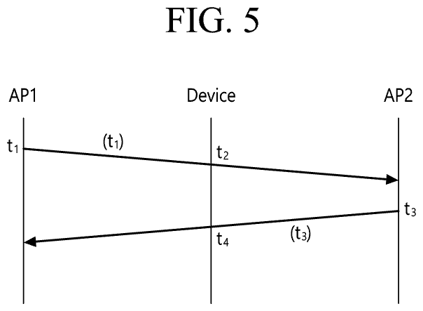

FIG. 5 shows an example scenario depicting necessary signaling to compute TDoA by a STA needing to know the STA's location in accordance with an embodiment. The example depicted in FIG. 5 is for explanatory and illustration purposes. FIG. 5 does not limit the scope of this disclosure to any particular implementation.

Referring to FIG. 5, the Device is a STA. AP1 transmits a first message to AP2 at t₁. The first message comprises t₁. The Device timestamps the time at t₂ which it overhears the first message. AP2 receives the first message from AP1. Subsequently, AP2 transmits a second message to AP1 at t₃. The second message comprises t₃. The Device timestamps the time at t₄ which it overhears the second message. AP1 receives the second message from AP2.

The target STA may determine its two-dimensional position by measuring the difference for at least 3 pairs of anchors, for a minimum of 4 anchors. The target STA determines its position based on the intersection of 3 or more hyperbolas. This method can be readily used in UWB where a ranging STA can be configured to monitor ranging participants without actively participating in ranging. As of recently, this method has been standardized by WiFi in IEEE 802.11az “Next Generation Positioning” as passive ranging.

Uplink TDoA is determined by a STA transmitting a message comprising the expected time of transmission. The message is received by a set of collaborating APs at different times. Similar to downlink TDoA, the STA determines a position based on a determination of a set of time differences and of a set of corresponding distance differences. The location of a mobile device may be determined by a cellular network. When applied to indoor positioning, the uplink TDoA may be used for position estimation by any technology through which inter-device distances may be determined.

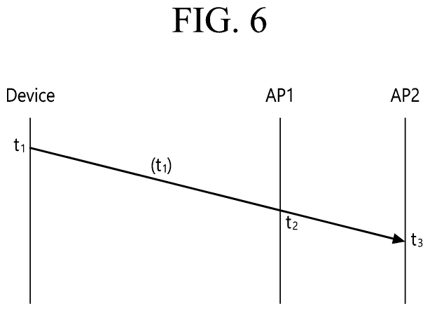

FIG. 6 shows an example scenario depicting the necessary signaling to compute the TDoA by a set of collaborating APs needing to estimate the position of a STA interested in accordance with an embodiment. The example depicted in FIG. 6 is for explanatory and illustration purposes. FIG. 6 does not limit the scope of this disclosure to any particular implementation.

Referring to FIG. 6, the Device is a STA. The Device transmits a message to AP2 at t₁. The message comprises t₁. AP1 timestamps the time at t₂ which it overhears the message. AP2 receives the message at t₃.

In position fixing, the received signal strength indicator (RSSI) is determined as the received power at a STA of interest by the transmit power an AP less propagation losses that are a function of the STA-AP distance. Using a standard propagation model, for example the International Telecommunication Union (ITU) indoor propagation model for WiFi, or a propagation model fitted on empirical data, the RSSI may be converted to generate a distance. One common model is the one-slope linear model expressing the relationship between RSSI and distance as shown in Equation 4.

$$RSSI = β + α \cdot log d \qquad Equation 4$$

In Equation 4, α and β are fitting parameters. Following the inversion of RSSIs to generate distances, standard positioning methods, for example trilateration that turn a set of distance measurements to a single position may be applied.

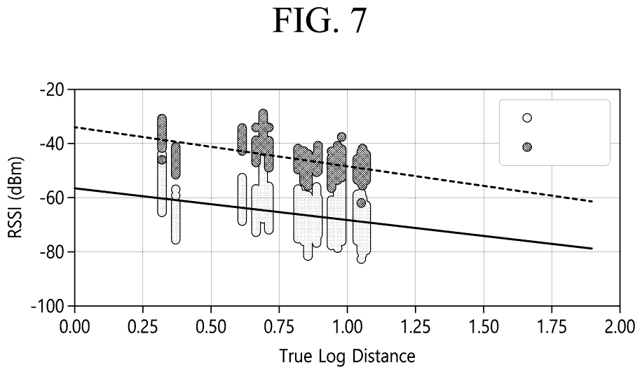

FIG. 7 shows an example scenario depicting obtaining distance by inverting the RSSI in accordance with an embodiment. The example depicted in FIG. 7 is for explanatory and illustration purposes. FIG. 7 does not limit the scope of this disclosure to any particular implementation.

Referring to FIG. 7, the first RSSI and the second RSSI are inverted generating the STA-AP distance. The first RSSI is represented by a solid line. The first RSSI corresponds to the collection of grey dots. The second RSSI is represented by a dashed line. The second RSSI corresponds to the collection of black dots.

In position fixing, the channel state information (CSI) is determined by a STA determining the channel frequency response or the channel impulse response. The channel impulse response expresses how the environment affects different frequency components in terms of both their magnitude and their phase. Monitoring the changes in phase over time and over a range of frequencies can be used to compute the STA-AP distance, and a wide range of methods, the details of which are beyond the scope of this document, exist for that purpose, for example multi-carrier phase difference used with Bluetooth low energy.

### Fingerprinting Technologies

In fingerprinting-based method, fingerprinting technologies follow a two-stage process. The first stage is known as the offline stage or the training stage. In this training stage a spatial database is constructed, mapping position identifiers such as rooms to features such as range measurements. The range measurements comprising RSSI in WiFi or Bluetooth, round-trip time (RTT), and sensor information. Sensor information comprising magnetic field, pressure and light. The second and final stage is known as the online stage or the operating stage. In the operating stage the database is queried using collected features and the position is looked up and returned.

A distinction needs to be made between fine-level positioning and coarse-level positioning. Fine-level positioning is concerned with the precise position of an object in a two- or three-dimensional user-defined coordinate system. Coarse-level positioning, however, looks for an answer in a discrete and finite set. The discrete nature of coarse-level positioning allows for fingerprinting to be used where a classifier can be used to tell apart different floors, sections, rooms, zones, or even tiles.

This disclosure provides a solution to a problem of coarse-level positioning, specifically device-based zone identification.

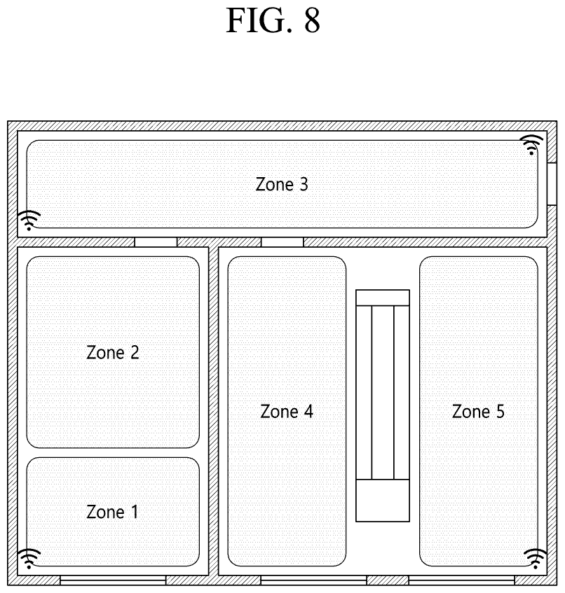

FIG. 8 shows an example scenario depicting a targeted premises with rooms comprising five different zones in accordance with an embodiment. The example depicted in FIG. 8 is for explanatory and illustration purposes. FIG. 8 does not limit the scope of this disclosure to any particular implementation.

Referring to FIG. 8, the target premises comprise three rooms. Zone 1 and Zone 2 are set up in a first room with a virtual boundary separating them. Zone 3 is set up in a second room by itself. Zone 4 and Zone 5 are set up in a third room separated by a virtual boundary as well as a physical obstacle.

### Pedestrian Dead Reckoning (PDR)

Dead reckoning is a method of estimating the position of a moving object using the object's last known position by adding incremental displacements to that last known position. Pedestrian dead reckoning, or PDR, refers specifically to the scenario where the object in question is a pedestrian walking in an indoor or outdoor space. With the proliferation of sensors inside smart devices, such as smartphones, tablets, and smartwatches, PDR has naturally evolved to supplement wireless positioning technologies that have been long supported by these devices such as WiFi and cellular service, as well as more recent and less common technologies such as ultra-wide band (UWB). The inertial measurement unit (IMU) is a device that combines numerous sensors with functional differences, such as the accelerometer measures linear acceleration; the gyroscope measures angular velocity; and the magnetometer measures the strength and direction of the magnetic field. These three sensors can estimate the trajectory of the device. Combining IMU sensor data and ranging measurements from wireless chipsets such as WiFi and UWB, or sensor fusion, can improve positioning accuracy by reducing uncertainty.

Sensors in the wireless device's IMU are no longer the sole source for step detection and movement tracking on smart devices. Due to the more recent proliferation of applications such as virtual reality, augmented reality, and autonomous driving, indoors (robotics) and outdoors, cameras are increasingly being used to track the position and orientation of objects in the environment including the very object they are attached to through a technique called visual inertial odometry. This has opened the door to positioning and tracking methods based on computer vision, including simultaneous localization and mapping (SLAM), structure from motion (SfM), and image matching.

### Fine Timing Measurement (FTM)

Fine Timing Measurement (FTM) is a wireless network management procedure defined in IEEE 802.11-2016 (unofficially known to be defined under 802.11mc) that allows a WiFi station (STA), to accurately measure the distance from other STAs such as an access point or an anchor point (AP) by measuring the RTT between the two. An STA wanting to localize itself, known as the initiating STA, with respect to other STAs, known as responding STAs, schedules an FTM session during which the STAs exchange messages and measurements. The FTM session consists of three phases: negotiation, measurement exchange, and termination.

In the negotiation phase, the initiating STA may negotiate key parameters with the responding STA, such as frame format, bandwidth, number of bursts, burst duration, burst period, and number of measurements per burst. The negotiation may start when the initiating STA sends an FTM request frame, which is a management frame with subtype Action, to the responding STA. The FTM request frame may be called the initial FTM request frame. This initial FTM request frame may include the negotiated parameters and their values in the frame's FTM parameters element. The responding STA may respond with an FTM frame called initial FTM frame, which approves or overwrites the parameter values proposed by the initiating STA.

The measurement phase consists of one or more bursts, and each burst consists of one or more (Fine Time) measurements. The duration of a burst and the number of measurements therein are defined by the parameters burst duration and FTMs per burst. The bursts are separated by interval defined by the parameter burst duration. In the negotiation phase, the initiating STA negotiates with the responding STA key parameters, such as frame format and bandwidth, number of bursts, burst duration, the burst period, and the number of measurements per burst.

In the termination phase, an FTM session terminates after the last burst instance, as indicated by parameters in the FTM parameters element.

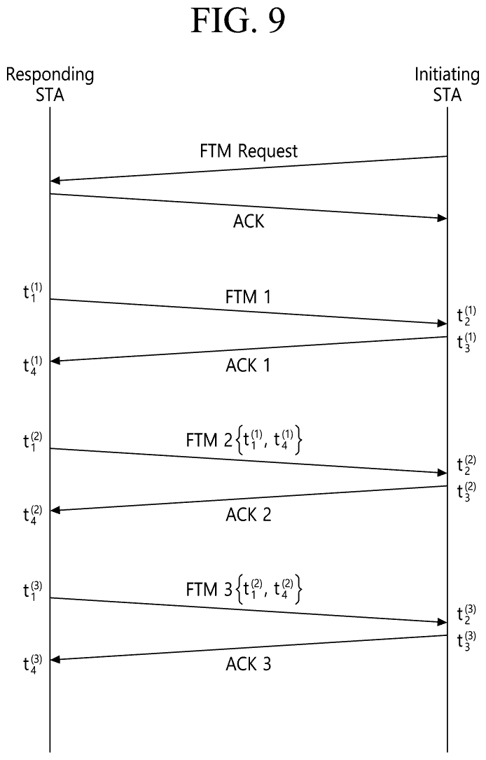

FIG. 9 shows an example scenario depicting an FTM session in accordance with an embodiment in accordance with an embodiment. In the example of FIG. 9, the FTM session includes one burst and three FTMs per burst.

Referring to FIG. 9, the initiating STA transmits an Initial FTM Request frame to the responding STA triggering the start of the FTM session. The responding STA transmits an acknowledgement block (ACK) to the initiating STA. Subsequently, the responding STA transmits the first FTM frame to the initiating STA and captures its transmission time t₁⁽¹⁾. The initiating STA receives the first FTM frame and captures its reception time t₂⁽¹⁾. The initiating STA transmits an ACK and captures its transmission time t₃⁽¹⁾. The responding STA receives the ACK from the initiating STA and captures its reception time t₄⁽¹⁾. The responding STA transmits a second FTM frame to the initiating STA and captures its transmission time t₁⁽²⁾. The initiating STA receives the second FTM frame and captures it reception time t₂⁽²⁾. The two STAs continue to exchange FTM frames and ACKs for as many measurements as were negotiated between the two STAs.

The second FTM frame in FIG. 9 serves two purposes. The second Frame is a follow-up to the first FTM frame and is used to transfer timestamps t₁⁽¹⁾ and t₄⁽¹⁾ recorded by the responding STA and the second Frame starts a second measurement. The initiating STA decodes the second FTM frame to generate the timestamps t₁⁽¹⁾ and t₄⁽¹⁾. Subsequently, the initiating STA determines RTT based on applying offset adjustments shown in Equation 5.

$$R T T = ( {t}_{4}^{( 1 )} - {t}_{1}^{( 1 )} ) - ( {t}_{3}^{( 1 )} - {t}_{2}^{( 1 )} ) \qquad Equation 5$$

A distance d is determined from the RTT of Equation 5 for positioning and proximity applications as shown in Equation 6.

$$d = \frac{R T T}{2} c \qquad Equation 6$$

Each FTM of the burst will yield a distance sample, with multiple distance samples per burst. A representative distance measurement may be determined by combining distance samples derived from multiple FTM bursts and multiple measurements per burst. For example, the mean distance, the median or some other percentile may be reported. Furthermore, other statistics such as the standard deviation could be reported as well to be used by the positioning application.

In an RTT-based indoor positioning system, the Wi-Fi enabled device ranges with a set of APs with pre-defined locations to estimate its position. The device constantly makes ranging requests to the APs and waits for ranging responses. The device may infer the distances to each of them from the responses. Finally, the device converts the set of distances into a position estimate using techniques such as trilateration, which is a common algorithm that minimizes the sums of square errors in distance between the device and each AP. Additionally, more sophisticated algorithms within the Bayesian framework can be employed.

### Trilateration

Trilateration is a method to determine the position of an object, in space or on a plane, using distances, or ranges, between the STA and 3 or more (multi-lateration) reference points, or anchor points (APs) with known locations. The distance between the STA and an AP can be measured directly, or indirectly as a physical quantity of time that is then converted into a distance. Two examples of such physical quantities are the ToF of a radio signal from the AP to the STA (or the opposite), and the RTT between the AP and the STA. Given there are three or more ranges, one with every AP, the position of the STA is determined as the intersection of three circles, each centered at one of the three APs.

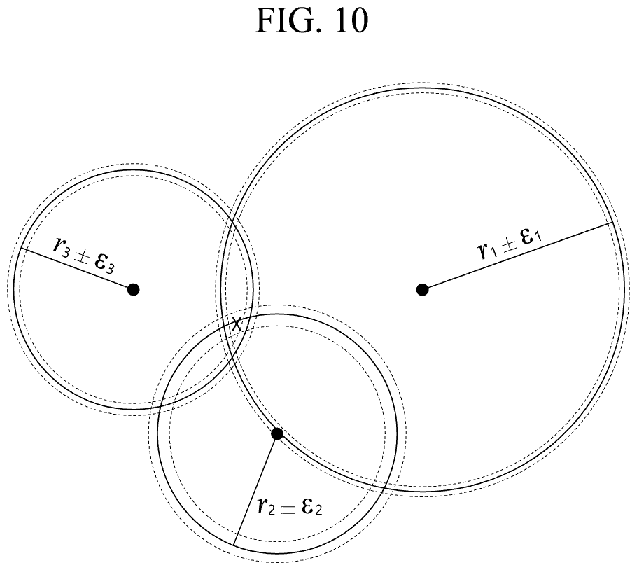

FIG. 10 shows an example scenario depicting trilateration in accordance with an embodiment. The example depicted in FIG. 10 is for explanatory and illustration purposes. FIG. 10 does not limit the scope of this disclosure to any particular implementation.

Referring to FIG. 10, there are three APs represented by points, the position of a STA represented by an X and three circles. The circles are each centered around one of the three APs. The circles have a radius determined by r±ε based on the positions of the AP and the STA. The circles intersect each other and the position X of the STA resides in an area intersected by all circles.

Determining the position of the STA may be done by different methods, either linear or non-linear. A common method is to define a non-linear least squares problem with the following objective function; as shown in Equation 7.

$$F ( p ) = F ( x , y , z ) = {\sum }_{a = 1}^{A} {f}_{a}^{2} ( p ) \qquad Equation 7$$

In Equation 7, ƒ_{α}(p) is the distance between the STA, currently at a position p, and AP α. The position p* would then be obtained by minimizing the objective function F(p) using general methods, for example Gauss-Newton or Levenberg-Marquardt.

In the case of a moving STA, a tracking algorithm from the Bayesian framework may be used to estimate the object's position at different points in time. The STA's anticipated trajectory may be expressed through a motion model, also known as a transition model. The STA's observed trajectory may also be expressed through a measurement model, or an observation model. The object's position may then be recursively determined from applying a two-step process to the measurements. The first step is the prediction step. In the prediction step, the position may be predicted solely from the motion model. The second step is the update step. In the update step, measurements may be used to correct the predicted position. The Bayesian filter may be implemented as a particle filter, also known as Monte-Carlo localization, grid-based filter, among many other implementations. If the motion and measurement models are linear, then the linear and efficient Kalman filter may be used. If the models may be easily linearized, then the extended Kalman filter may be used.

### Bayesian Filter

The Bayesian framework is a mathematical tool used to estimate the state of an observed dynamic system or its probability. In this framework, the trajectory of the system is represented by a motion model, also known as a state transition model, which describes how the system evolves over time. The measurement of a state is expressed through a measurement model or an observation model, which relates the state or its probability at a given time to measurements collected at that time. With an incoming stream of measurements, the state of the system is recursively estimated in two stages, measurement by measurement. In the first stage, known as the prediction stage, the state at a point in the near future is predicted solely using the motion model. In the second stage, known as the update stage, measurements are used to correct the prediction state. The successive application of the prediction stage and update stage gives rise to what is known as the Bayesian filter. Mathematical details are provided below.

The motion model describes the evolution of the state of the system and relates the current state to the previous state. There are two ways to express the relationship: direct relationship and indirect relationship.

In the direct relationship, the new (next) state xₖ may be expressed as a random function of the previous state xₖ₋₁ and input to the system uₖ as shown in Equation 8.

$${x}_{k} = f ( {u}_{k} , {x}_{k - 1} ) \qquad Equation 8$$

Indirect relationship: a transition kernel may be provided as shown in Equation 9.

$$p ( {x}_{k} \vert {x}_{k - 1} , {u}_{k} ) \qquad Equation 9$$

Measurement Model relates the current observation to the current state. Similarly, there are two ways to express this relationship: direct relationship and indirect relationship.

In the direct relationship, the observation yₖ can be expressed as a random function of the current state xₖ as shown in Equation 10.

$${y}_{k} = g ( {x}_{k} ) \qquad Equation 10$$

In the indirect relationship, the likelihood distribution can be provided as shown in Equation 11.

$$p ( {y}_{k} \vert {x}_{k} ) \qquad Equation 11$$

Initially, the Bayesian filter starts with a belief b₀(x₀)=p(x₀) about the state of the system at the very beginning. At each time index k, the Bayesian filter refines the belief of state of system by applying the prediction stage followed by the update stage. The state of the system can then be estimated from the belief, as the minimum mean square error estimate (MMSE), the maximum a posteriori estimate (MAP), or other methods.

In the Prediction stage, the Bayesian filter determines ‘a priori’ belief bₖ⁻(sₖ) using the state transition model as shown in Equation 12.

$${b}_{k}^{-} ( {s}_{k} ) = \int \int {b}_{k - 1} ( s ) p ( s \vert {s}_{k - 1} , {u}_{k} ) d s \qquad Equation 12$$

In the updated stage, the Bayesian filter updates ‘a posteriori’ belief bₖ(sₖ) using the measurement model as shown in Equation 13.

$${b}_{k} ( {s}_{k} ) = {b}_{k}^{-} ( {s}_{k} ) \cdot p ( {y}_{k} \vert {s}_{k} ) \qquad Equation 13$$

Once the ‘a posteriori’ belief has been determined, the state can be estimated in various ways as shown in Equation 14 and Equation 15.

$${\hat{s}}_{A}^{MAP} = {arg max}_{s} {b}_{k} ( s ) \qquad Equation 14$$

$${\hat{s}}_{k}^{MMSE} = \int \int {b}_{k} ( s ) ds \qquad Equation 15$$

### Kalman Filter

When both of the motion model and the measurement model are linear, the Bayesian filter reduces to the well-known Kalman filter. The motion and measurement equations for a linear system, and the prediction stage and the update stage for the corresponding Kalman filter are described below.

The motion equation describes the evolution of the state of the system and relates the current state to the previous state as shown in Equation 16.

$${x}_{k} = {A}_{k} {x}_{k - 1} + {B}_{k} {u}_{k} + {v}_{k} \qquad Equation 16$$

In Equation 16 xₖ is the current state, xₖ₋₁ is the last state, Aₖ is the state transition matrix, uₖ is the current input, Bₖ is the control/input matrix, and vₖ˜N(0,Qₖ) is the process noise which represents uncertainty in state.

The measurement equation relates the current observation to the current state as shown in Equation 17.

$${y}_{k} = {H}_{k} {x}_{k} + {w}_{k} \qquad Equation 17$$

In Equation 17 yₖ is the latest observation, Hₖ is the observation matrix, and wₖ˜N(0,Qₖ) is the observation noise.

At each time index k, the Kalman filter estimates the state of the system by applying a prediction stage followed by an update stage. The outcome of these two steps is the state estimate \hat{x}ₖ at time index k and the covariance matrix Pₖ which are in turn used to estimate the states at later points in time.

In the prediction stage, the Kalman filter predicts the current state \hat{x}_{k|k-1} (a priori estimate) from the most recent state estimate \hat{x}ₖ₋₁, the covariance Pₖ₋₁, and any inputs using the motion equation as shown in Equation 18 and Equation 19.

$${\hat{x}}_{k \vert k - 1} = {A}_{k} {\hat{x}}_{k - 1} + {B}_{k} {u}_{k} , \qquad Equation 18$$

$${P}_{k \vert k - 1} = {A}_{k} {P}_{k} {A}_{k}^{*} + {Q}_{k} , \qquad Equation 19$$

In the update stage, the Kalman filter uses the latest observation to update the prediction and obtain the ‘a posteriori’ state estimate \hat{x}ₖ and its covariance Pₖ as shown in Equation 20 and Equation 21.

$${\hat{x}}_{k} = {\hat{x}}_{k \vert k - 1} + {K}_{k} ( {y}_{k} - {H}_{k} {\hat{x}}_{k \vert k - 1} ) \qquad Equation 20$$

$${P}_{k} = ( I - {K}_{k} {H}_{k} ) {P}_{k \vert k - 1} \qquad Equation 21$$

In Equation 20 and Equation 21 Kₖ is the Kalman gain and is a function of the ‘a priori’ estimate covariance P_{k|k-1}, observation matrix Hₖ, and observation noise covariance matrix Rₖ.

The extended Kalman filter (EKF) is a method to handle non-linearities in the motion model or measurement model. If the motion equation or the measurement equation is not linear, the Kalman filter may not be used unless these equations are linearized. Consider the following non-linear motion equation as shown in Equation 22 and measurement equation as shown in Equation 23.

$${x}_{k} = {f}_{k} ( {x}_{k - 1} , {u}_{k} ) + {v}_{k} \qquad Equation 22$$

$${y}_{k} = {h}_{k} ( {x}_{k} ) + {w}_{k} \qquad Equation 23$$

In Equation 22 and Equation 23 fₖ and hₖ are non-linear functions. The EKF applies the predict stage and update stage as described below.

In the prediction stage, Equation 24 is utilized to determine \hat{x}_{k|k-1} and Equation 25 is utilized to determine P_{k|k-1}.

$${\hat{x}}_{k \vert k - 1} = {f}_{k} ( {\hat{x}}_{k - 1} , {u}_{k} ) \qquad Equation 24$$

$${P}_{k \vert k - 1} = {F}_{k} {P}_{k} {F}_{k}^{*} + {Q}_{k} \qquad Equation 25$$

In Equation 24 and Equation 25, Fₖ is determined according to Equation 26.

$${{F}_{k} = \frac{\partial {f}_{k} ( x , u )}{\partial x} \vert}_{x = {\hat{x}}_{k - 1} , u = {u}_{k}} \qquad Equation 26$$

In the update stage, Equation 27 is utilized to determine \hat{x}ₖ and Equation 28 is utilized to determined Pₖ.

$${\hat{x}}_{k} = {\hat{x}}_{k \vert k - 1} + {K}_{k} ( {y}_{k} - {H}_{k} {\hat{x}}_{k \vert k - 1} ) \qquad Equation 27$$

$${P}_{k} = ( I - {K}_{k} {H}_{k} ) {P}_{k \vert k - 1} \qquad Equation 28$$

In Equation 27 and Equation 28, Fₖ is determined by Equation 29.

$${{F}_{k} = \frac{\partial {h}_{k} ( x )}{\partial x} \vert}_{x = {\hat{x}}_{k - 1}} \qquad Equation 29$$

The state estimate \hat{x}ₖ and the covariance Pₖ are propagated to track the state of system. In the context of positioning, the state refers to the device position. In the context of Wi-Fi RTT indoor positioning, the observation refers to the RTT distance measurement.

### Multi-Dimensional Scaling

Multi-dimensional scaling (MDS) is a statistical framework for constructing a geometric representation of a set of objects, in this case STAs and APs, from information about some form of similarity or distance (dissimilarity) between them. Multi-dimensional scaling has applications in a diverse set of fields. In Geography, it may be used to represent cities on a map given the distances between one another. In Economics, it may be used to visualize countries in N-dimensional space using information on imports and exports between every pair of trade partners. In Genetics, it may be used to visualize genes in a gene correlation map using the similarity in their biological functions. But most relevant to this disclosure, in positioning, it may be used to localize anchor points, also known as reference points, in a two-dimensional plane or three-dimensional space using range measurements between one another.

Mathematically, the problem posed by MDS is minimizing a loss function as shown in Equation 30. The loss function may also be known as the stress.

$$f ( X ) = {\sum }_{i = I}^{N} {\sum }_{j = 1}^{N} {( {δ}_{ij} - {d}_{ij} ( X ) )}^{2} \qquad Equation 30$$

In Equation 30, X is the N×D coordinate matrix in D-dimensional space, N is the number of STAs and APs, δᵢⱼ is the measured distance between elements i and j, and dᵢⱼ (X) is their Euclidean distance in the embedding space, which is the low-dimensional space where the elements are represented or visualized.

The Torgerson method provides a closed form solution to determine X and may be applied when the distances between the elements are themselves Euclidean distances. This is the case when positioning a set of anchor points relative to one another.

The Torgerson method comprises: determining the distance matrix D whose entries [D]ᵢⱼ≡=∥xᵢ−xⱼ∥=δᵢⱼ where {δᵢⱼ} are the measured distances; determining the matrix M whose entries are

$${[ M ]}_{ij} = \frac{{D}_{1 j}^{2} + {D}_{i 1}^{2} - {D}_{ij}^{2}}{2} ;$$

factorizing the matrix M as M=UκU⁻¹ where U is the column matrix of eigenvectors of M and κ is a diagonal matrix of its eigenvalues; factorizing the Gram matrix M as M=\tilde{X}\tilde{X}^{T} and based on the equivalencies as shown in Equation 31; determining the m×m coordinate matrix \tilde{X}=U\sqrt{κ} where m is the number of STAs and APs and then extracting the submatrix [\tilde{X}]ᵢ_{₁}_{, . . . i}_{ₙ} where the column indices i₁ . . . iₙ correspond to the non-zero columns of the matrix \tilde{X}.

$$\tilde{X} {\tilde{X}}^{T} = U Λ {U}^{- 1} = U Λ {U}^{T} = ( U \sqrt{Λ} ) {( U \sqrt{Λ} )}^{T} \qquad Equation 31$$

Other optimization algorithms under the MDS framework target different objectives. The stress majorization algorithm (SMACOF) targets the objective of minimizing the weighted stress as shown in Equation 32.

$$f ( X ) = {\sum }_{i = 1}^{N} {\sum }_{j = 1}^{N} {{w}_{ij} ( {δ}_{ij} - {d}_{ij} ( X ) )}^{2} \qquad Equation 32$$

The Sammon mapping algorithm targets the objective of minimizing the Sammon stress defined as shown in Equation 33.

$$f ( X ) = ( \frac{1}{{\sum }_{i = 1}^{N} {\sum }_{j = 1}^{N} {δ}_{ij}} ) \cdot {\sum }_{i = 1}^{N} {\sum }_{j = 1}^{N} \frac{{( {δ}_{ij} - {d}_{ij} ( X ) )}^{2}}{{δ}_{ij}} \qquad Equation 33$$

The coordinate matrix \tilde{X} will be an orthogonal transformation, such as rotation, reflection, or combination thereof, of the matrix X containing the true coordinates from which the distance matrix D was obtained.

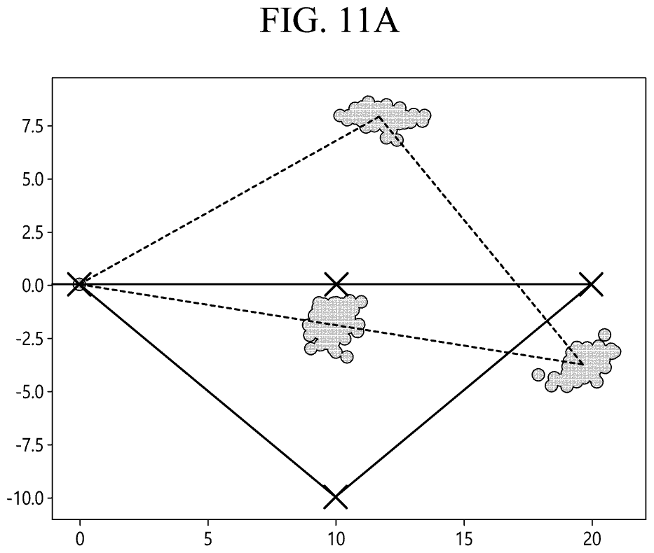

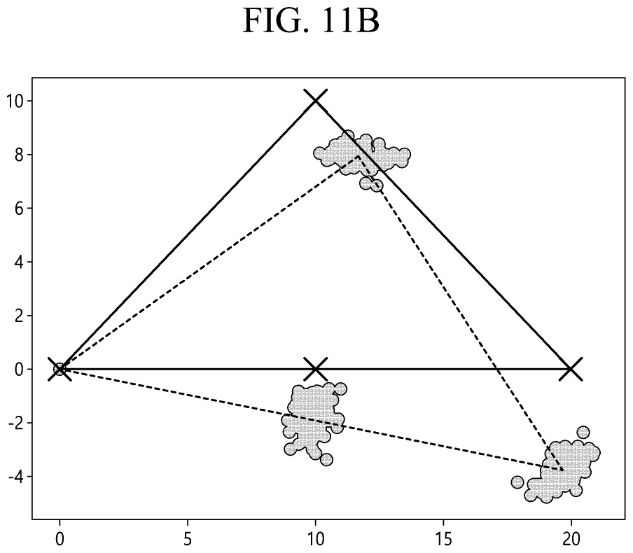

FIG. 11A shows an example scenario depicting orthogonal transformation using rotation and reflection in accordance with an embodiment.

Referring to FIG. 11A, the “X”s are true anchor point coordinates. The solid lines connect true anchor point coordinates. The dashed lines connect estimated coordinates. The dots correspond to instances of measured pairwise distances. In FIG. 11A the estimated coordinates are rotated and reflected.

FIG. 11B shows an example scenario depicting orthogonal transformation using rotation in accordance with an embodiment.

Referring to FIG. 11B, the “X”s are true anchor point coordinates. The solid lines connect true anchor point coordinates. The dashed lines connect estimated coordinates. The dots correspond to instances of measured pairwise distances. In FIG. 11B the estimated coordinates are rotated.

### The Solution

There are two key issues with existing solutions. The user may need to prepare and input a floorplan of the target premises and define the zones with respect to the floorplan. Some solutions build their own floorplan by requiring the user to scan the target premises with their device's camera. The user may need to define the coordinates of the anchor points with respect to the floorplan. In this disclosure, the device may not know the floorplan of the premises, the placement of the zones, or the locations of the anchor points. The device may only need to know the number of zones and the hardware (MAC) addresses of the anchor points.

The solution described in this disclosure comprises four phases. The four phases include a setup phase, a management phase, a training phase, and an inference phase. In the setup phase, APs may identify the relative locations of one another through an auto-localization process. In the management phase, the user may train new zones, amend existing ones, and put the solution into operation. In the training phase, the user may train location identification models by walking around the previously registered zones, one zone at a time. In the inference phase, the models may be deployed to perform online inference also known as location identification in real time.

The solution may require two hardware components. The solution requires mobile device(s), or STA(s), whose location needs to be identified. Such STAs include smartphones, smartwatches, wearable and tablets. The solution requires APs serving as reference points, including traditional wireless infrastructure. Such APs include a WiFi router, a UWB tag, a Bluetooth beacon, as well as smart home devices, such as smart home hub, smart TV and smart fridge. The solution or parts thereof may be implemented on a mobile device whose location needs to be identified as an application, a local device, such as a smart home hub, a remote server or the cloud. The operations of the solution may be performed by, for example and without limitation, a user STA. In describing the operations of the solution, the disclosure may refer to “a user STA” or “the user STA”, which describe the solution as implemented on a device. APs and STAs, while typically being WiFi devices, may use any other wireless technology, such as UWB, Bluetooth, or any other comparable wireless technology not yet known. Any embodiments of this invention described using this implemented description shall not act as a limitation on the disclosure.

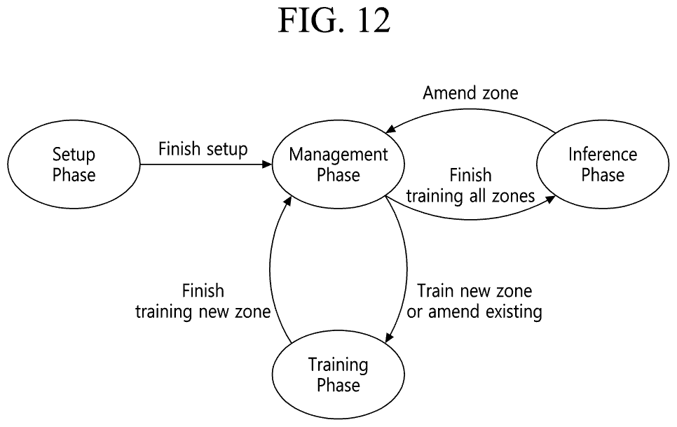

FIG. 12 shows a flowchart demonstrating the four phases of zone prediction in accordance with an embodiment of this disclosure in accordance with an embodiment.

Referring to FIG. 12, there are four phases. The four phases are the setup phase, the management phase, the inference phase and the training phase. After the device finishes setting up, then the management phase begins. The management phase may comprise training new zones or amending existing zones. The management phase may also comprise initiating operation. When the management phase trains a new zone or amends an existing one then the training phase begins. When the training or amending of zones is complete, then the management phase will begin again. If the management phase finds that the training of all zones is complete, then it may begin the inference phase. The inference phase may result in amending one or more zones.

Wireless technologies, such as WiFi, Bluetooth and UWB, may provide different types of measurements from which distance may be inferred. Examples of different types of measurements for inferring distance include time of flight (ToF), round-trip time (RTT) and received signal strength indicator (RSSI)

The ToF and the RTT may be converted into a distance by direct scaling if the underlying wireless subsystem providing said measurements does not already do that. The RSSI may be converted into a range measurement by applying an inverse function that maps RSSI back into a distance. The conversion process may be an analytical, indoor propagation model taking multiple parameters. Those parameters may include a channel frequency, a bandwidth, an analytical multivariate model fit empirically to collected data and a machine learning model trained on collected data.

The setup phase comprises three processes. In the setup phase, the first process prompts the user to input parameters for a STA. Those parameters may include the number of zones, the number of APs, and the identities of APs in the form of the APs' MAC addresses, for example, or in the form of other unique identifiers. The second process requests that every pair of APs to range with one another. The third process performs AP auto-localization using the ranging data and assigns a (location) coordinate to every AP.

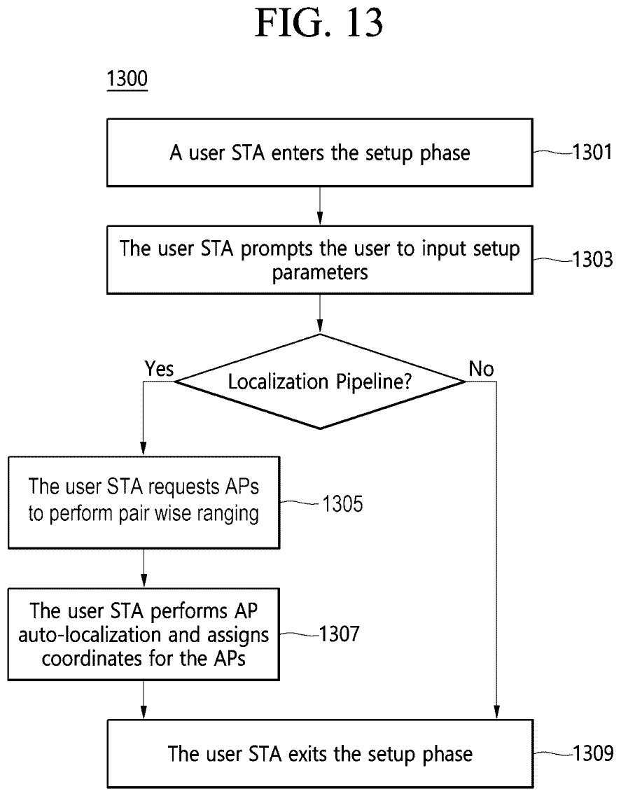

FIG. 13 shows a flowchart demonstrating the operations of a user STA corresponding to the Setup Phase of the Training Phase in accordance with an embodiment.

Referring to FIG. 13, the setup phase, process 1300, begins at operation 1301. In operation 1301, a user STA enters the setup phase.

In operation 1303, the user STA may prompt a user to input setup parameters, those parameters including number of zones, number of APs, and addresses of the APs. Operation 1303 is followed by operation 1305 is a localization pipeline is used. Operation 1303 is followed by operation 1309 if a localization pipeline is not used.

In operation 1305, the user STA may request the APs to perform pair-wise ranging.

In operation 1307, the user STA performs AP auto-localization and assigns coordinates for the APs.

In operation 1309, the user STA exits the setup phase.

In AP auto-localization, also known as self-localization, a set of devices identify their positions relative to one another. In one embodiment, the auto-localization process may use the MDS framework introduced earlier to run the Torgerson, Sammon, or SMACOF algorithms. In another embodiment the auto-localization process may use a non-linear least squares algorithm to minimize a loss function on the set of pairwise ranges {r_{i,j,t}}, where i and j are AP identifiers and t is a time index, to assign every AP i a coordinate \hat{p}ᵢ in two- or three-dimensional space.

In the management phase, the solution may provide the user with a dashboard comprising a number of tasks that may be performed. Those tasks include training a new (untrained) zone which will enter the training phase, amending existing (trained) zone which will enter the Training Phase, and deploying into operation which will enter the Inference Phase.

In the training phase, the user STA performs training processes. Those training processes include prompting the user to move around in one or more ways, collecting data as the user moves, training its models in the zone selected by the user. In an embodiment, the user may be prompted to walk randomly in the zone interior, zigzag across the zone, walk along the zone boundary and/or walk along the zone boundary once clockwise and again counter-clockwise. The data collected may include ranges with APs such as WiFi RSSI, WiFi RTT and Bluetooth RSSI, inertial sensor readings such as acceleration and rotational velocity and other sensor readings such as magnetic field, pressure and light. A camera may also be used. The models may be trained using the collected data as inputs or features and the zone ID selected by the user may be the output or label. In an embodiment, the user STA may collect data as described above and train its models as described above one after the other as data is streaming in real time.

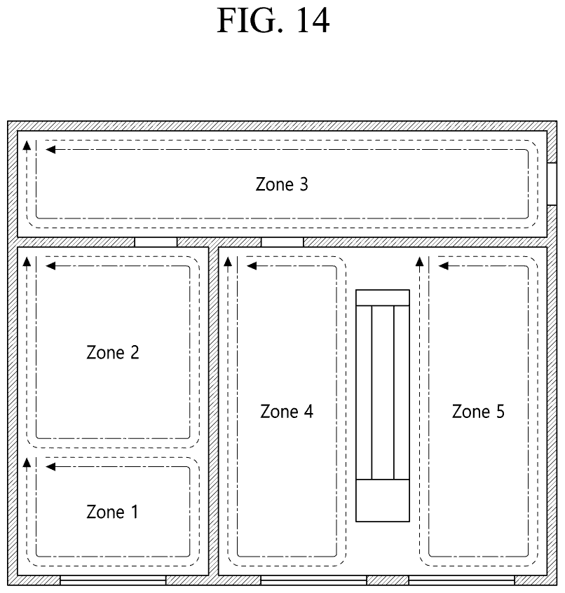

FIG. 14 shows an example scenario of a user STA performing the training phase on a premises featuring five selected zones in accordance with an embodiment.

Referring to FIG. 14, there are five zones and a premises comprising three rooms. Zone 1 and Zone 2 occupy the first room with a virtual boundary separating them from each other. Zone 3 occupies the second room alone, separated from the other zones by the walls of the room. Zone 4 and Zone 5 occupy the third room with both a virtual boundary and a physical boundary separating them from each other.

In FIG. 14, every zone has two dotted lines outlining the zone. These two dotted lines are directed in opposite direction, one clockwise and the other counterclockwise. The dotted lines represent the training, by the user, of the zones by walking once clockwise along the zone boundary and again counterclockwise.

During the training phase, the localization pipeline may be used to produce zone signatures that characterize position estimates in the different zones. A zone signature S is a set of points, or a set-like object, that may be tested for the membership of a two- or three-dimensional coordinate pair x. A zone signature supports testing the condition x∈S. The simplest example of a zone signature is a polygon.

If the localization pipeline is used for zone identification, the user STA performs additional processes in the training phase. One such process may include computing the initial position of the user's device inside the selected zone using the earliest range measurements by trilateration, and using that to initialize a tracking filter, such as the Kalman filter, the extended Kalman filter, or any Bayesian filter. Another process may include tracking the trajectory of the device inside the selected zone as the user moves around, producing a sequence of position estimates {\hat{x}ₖ} corresponding to the time sequence of range measurements {rₖ} or group of measurements, using additional data such as inertial or other sensor readings. Yet another process may include converting the sequence of position estimates {\hat{x}ₖ} into zone signatures {S_{z}} corresponding to the zones {z} defined by the user. These zone signatures may be the convex hulls of the set of points {\hat{x}ₖ} of every zone, which is a set of polygons, the concave hulls of the set of points {\hat{x}ₖ} of every zone, which is a set of polygons or a classifier, such as K-Nearest Neighbors. K-Nearest Neighbors acts as a record book that maps points to their corresponding label as well as a means to label a point not in the record book of points.

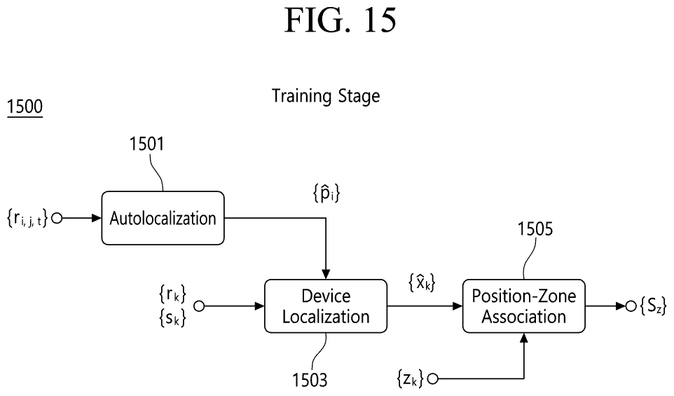

FIG. 15 shows an example scenario of a user STA performing the training phase using autolocalization in accordance with an embodiment.

Referring to FIG. 15, the training phase, process 1500, begins at operation 1501. In operation 1501 the user STA performs AP autolocalization in the setup phase to assign the APs coordinates in a virtual space where those APs coordinates were not known.

In operation 1503, the user STA performs device localization, determining the device trajectory {\hat{x}ₖ}. The device trajectory {\hat{x}ₖ} is determined using a sequence of range measurements {rₖ} and sensor readings {sₖ}, derived from the virtual coordinates of the APs.

In operation 1505, the user STA builds the signature zone S_{z} by grouping together position estimates belonging to the same zone. The signature zone S_{z} is later used in the inference phase to test for membership of a position estimated in real time.

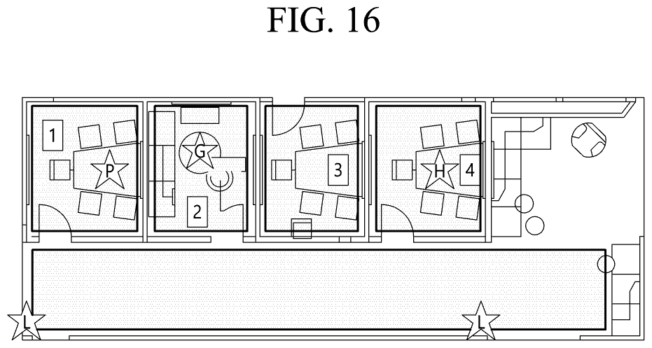

FIG. 16 shows an example scenario depicting a premises featuring five zones, a row of four rooms and a hallway in accordance with an embodiment.

Referring to FIG. 16, there are five zones, a row of four rooms and a hallway. There are five APs. The APs are AP P, AP G, AP H, AP I and AP L. The rooms are Room 1, Room 2, Room 3, and Room 4. The hallway is located below the rooms. AP P is in Room 1. AP G is in Room 2. AP His in Room 4. AP L and AP I are in the hallway. The user STA in FIG. 16 may only use a maximum of five APs for zone detection.

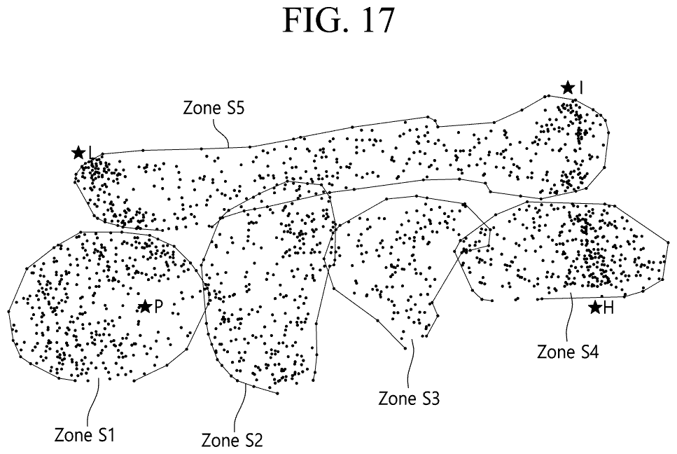

FIG. 17 shows an example scenario depicting the determination of zones by auto-localization featuring four APs in accordance with an embodiment.

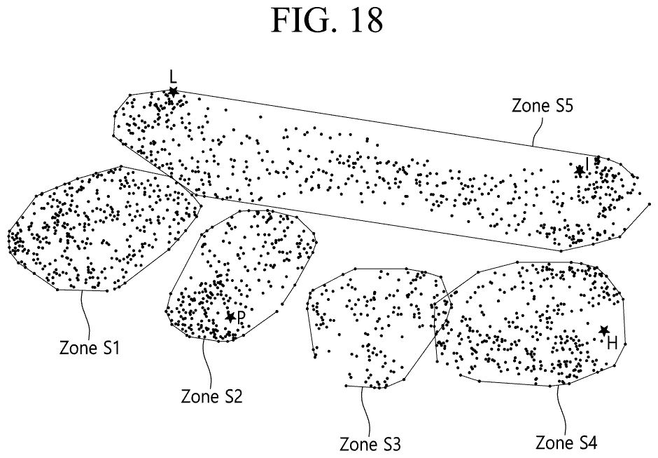

Referring to FIG. 17, there are four APs whose coordinates are represented by stars. Those four APs are AP H, AP I, AP L and AP P. The four APs are present in the virtual coordinate space as determined by the auto-localization algorithm. There are five zone signatures, zone S1, zone S2, zone S3, zone S4 and zone S5. Every zone signature is a concave hull, a polygon, of the device position estimates in a corresponding zone. AP P resides in zone S1. AP L and AP I do not reside in any zone but are closest to zone S5. FIG. 18 shows another example scenario depicting the determination of zones by auto-localization featuring four APs in accordance with an embodiment.

Referring to FIG. 18, there are four stars representing the virtual coordinates of the four APs in the virtual coordinate space as determined by the auto-localization algorithm. The APs are AP P, AP L, AP I, and AP H. There are five zone signatures. The zone signatures are zone S1, zone S2, zone S3, zone S4 and zone S5. Every zone signature is a convex hull, a polygon, of the device position estimates in a corresponding zone. AP P resides in zone S2. AP L and AP I reside in zone S5. AP H resides in zone S4.

The fingerprinting pipeline may be used as an alternative to the localization pipeline for zone identification. The fingerprinting pipeline may also be used in conjunction with the localization pipeline to enhance zone prediction accuracy. If the fingerprinting pipeline is used on its own, then the AP auto-localization step in the setup phase is skipped. During the training phase, the user STA performs the same processes at in AP auto-localization. In addition, the user STA also trains one or more classifiers using collected range and sensor data as inputs or features and using the identity of the zone selected by the user as the corresponding output or label. The classifiers may be supervised learning models such as support vector machines (SVMs) and kernel SVMs using the radial basis function, decision trees, random forests and other classifiers.

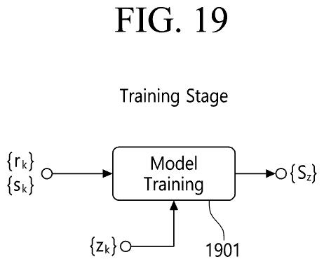

FIG. 19 shows an example scenario depicting supervised training of classifiers in accordance with an embodiment.

Referring to FIG. 19, model training 1901 provides that supervised training of classifier(s) is performed. A user STA may train classifiers using the time sequence of ranges with the APs {rₖ} and sensor readings {sₖ} as inputs, and the identity of the zone selected by the user as the class label generating a set of signature zones S_{z}.

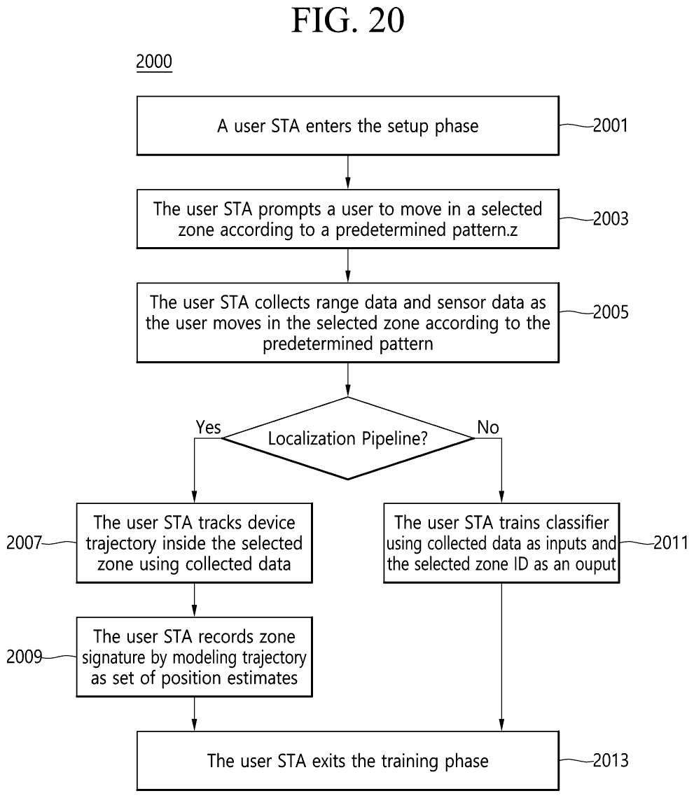

FIG. 20 shows a flowchart demonstrating the operations of a user STA corresponding to the training phase in accordance with an embodiment.

Referring to FIG. 20, the training phase, process 2000 begins at operation 2001. In operation 2001, a user STA enters the training phase.

In operation 2003, the user STA prompts the user to move in a selected zone according to a predetermined pattern.

In operation 2005, the user STA collects range data and sensor data as the user moves in the selected zone according to the predetermined pattern. Operation 2005 is followed by operation 2007 if a localization pipeline is used. Operation 2005 is followed by operation 2011 if a localization pipeline is not used.

In operation 2007, the user STA tracks device trajectory inside the selected zone using the collected data.

In operation 2009, the user STA records zone signature by modeling trajectory as a set of position estimates.

In operation 2011, the user STA trains a classifier using collected data as inputs and the selected zone ID as an output.

In operation 2013, the user STA exits the training phase.

If the localization pipeline is used then the user STA tracks device trajectory inside the selected zone using collected data. Subsequently, the user STA records the zone signature by modeling trajectory as a set of position estimates. Afterwards, the user STA would then exit the training phase. If the localization pipeline is not used then the user STA trains the classifier using collected data as inputs and selected zone ID as the output. Afterwards, the user STA would then exit the training phase.

During the inference phase, the user STA continuously collects range data and sensor data and continuously generates zone predictions. If the localization pipeline is used, the user STA performs the processes described below. The user STA ranges with APs at every estimation epoch k and collects the sensor readings since the last epoch. The user STA then determines device position \hat{x}ₖ using the APs' estimated coordinates {\hat{p}ᵢ} as well as the collected data and the same positioning algorithm used in the training phase. The user STA determines membership of the device position in the different zone signatures \hat{x}ₖ∈S_{z}, for ∀z. The user STA determines membership for device positions where the device position has multiple memberships or no memberships. The user STA's determination of membership is based on the following factors. If zone signatures are geometrical shapes (polygons) then the following factors are considered. If a device position belongs to multiple zones, then the distances between the device position and the zone centers are computed, and the computed distance determines the membership of the device position based on the zone corresponding to the smallest distance. If a device position belongs to no zone the distances between the estimate and the zone boundary are computed, and the user STA determines the membership of the device position based on the zone corresponding to the smallest distance is returned. The user STA may also determine the membership of the device position which belongs to no zone to be a membership of an “unknown zone”. If zone signatures are defined by training a classifier, then the classifier may determine the membership of the device position.

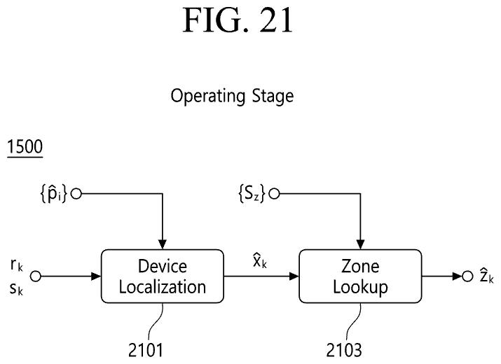

FIG. 21 shows operations of a user STA in utilizing a positioning algorithm in predicting a device's position in accordance with an embodiment.

Referring to FIG. 21, the operating phase, process 2100, begins at operation 2101. In operation 2101, the AP coordinates {\hat{p}ᵢ}, assigned by the auto-localization algorithm in the setup phase, the ranges collected with the APs rₖ and the sensor readings sₖ are used in the positioning algorithm to determine a device's position \hat{x}ₖ.

In operation 2103, the user STA determines the coarse-location \hat{z}ₖ based on the device's position \hat{x}ₖ and the zone signatures {S_{z}}.

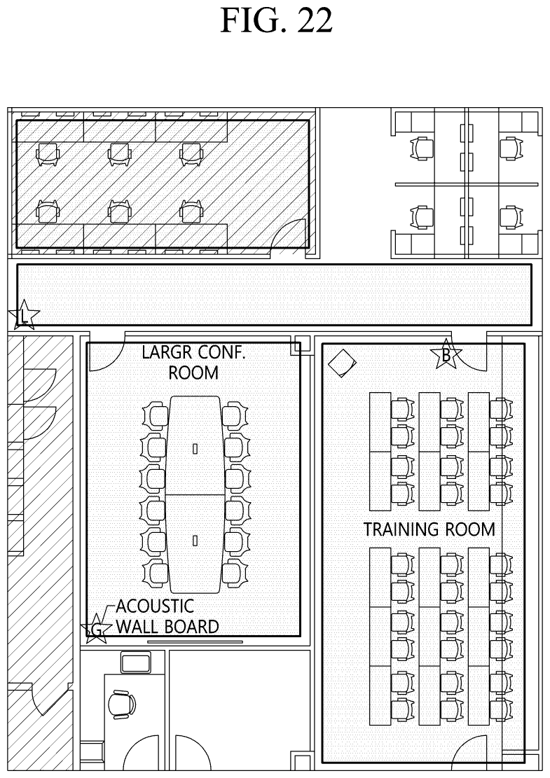

FIG. 22 shows an example scenario of a premises comprised of four zones in accordance with an embodiment.

Referring to FIG. 22, there are four zones on the premises. The four zones include three rooms and a hallway. There are three APs on the premises, AP L, AP B, and AP G. AP L is located in the zone in the hallway. AP B is in the zone in the training room. AP G is in the zone in the larger conference room. AP L, AP B and AP G are used in zone detection for the four zones.

If the fingerprinting pipeline is used, the user STA performs the following actions. The user STA ranges with APs and collects sensor readings. The user STA performs model inference or model prediction on a classifier using the range and sensor data and returns the predicted class. If multiple classifiers have been trained to enhance zone prediction accuracy, then inference is performed on all classifiers and their predictions are merged using techniques from ensemble learning such as simple or weighted majority voting.

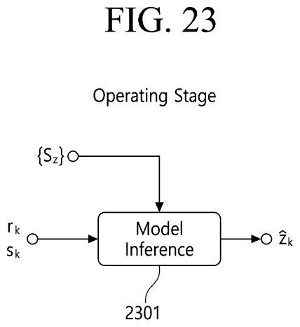

FIG. 23 shows the operation of a user STA performing model inference in accordance with an embodiment.

Referring to FIG. 23, operating phase 2301 provides that a user STA performs model inference on the trained classifier(s) using the ranges with the APs rₖ and the sensor readings sₖ as inputs. The user STA determines the predicted class \hat{z}ₖ is determined as the predicted zone.

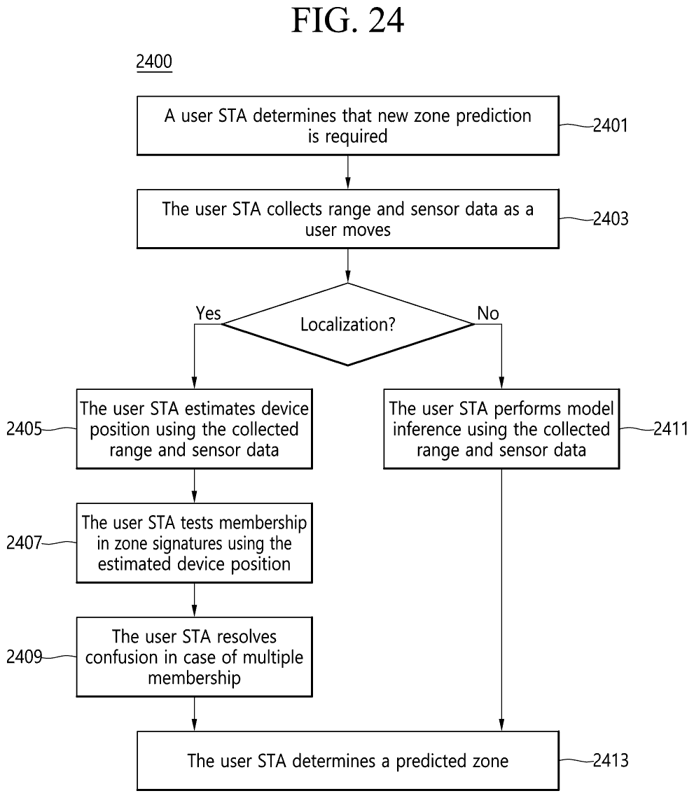

FIG. 24 shows a flowchart of the operations of a user STA corresponding to the performed in the inference phase in accordance with an embodiment.

Referring to FIG. 24, the inference phase, process 2400, begins at operation 2401. In operation 2401, a user STA determines that new zone prediction is required.

In operation 2403, the user STA collects range and sensor data as a user moves. Operation 2403 is followed by operation 2405 if localization is used. Operation 2403 is followed by operation 2411 if localization is not used.

In operation 2405, the user STA estimates device position using the collected range and sensor data. The user STA may be the device.

In operation 2407, the user STA tests membership in zone signatures using the estimated device position.

In operation 2409, the user STA resolves confusion in case of multiple membership. A case of multiple membership occurs where the estimated device position is within more than one zone signature.

In operation 2411, the user STA performs model inference using the collected range and sensor data.

In operation 2413, the user STA determines a predicted zone.

Zone amendment occurs as a result of the training phase or the inference phase. After training on the different zones and while in the Inference Phase, the user STA provides the user with a means to refine, or amend, the zone definitions such as expansion or contraction. The user STA moves from the Inference Phase back into the Management Phase, where the user may select the zone to amend, after which the user STA transitions into the Training Phase where it prompts the user to walk in the zone. As the user walks, the device on them ranges with the anchor points and collects sensor data to be used to train the models. Zone retraining, refinement, and update are all synonyms to zone amendment.

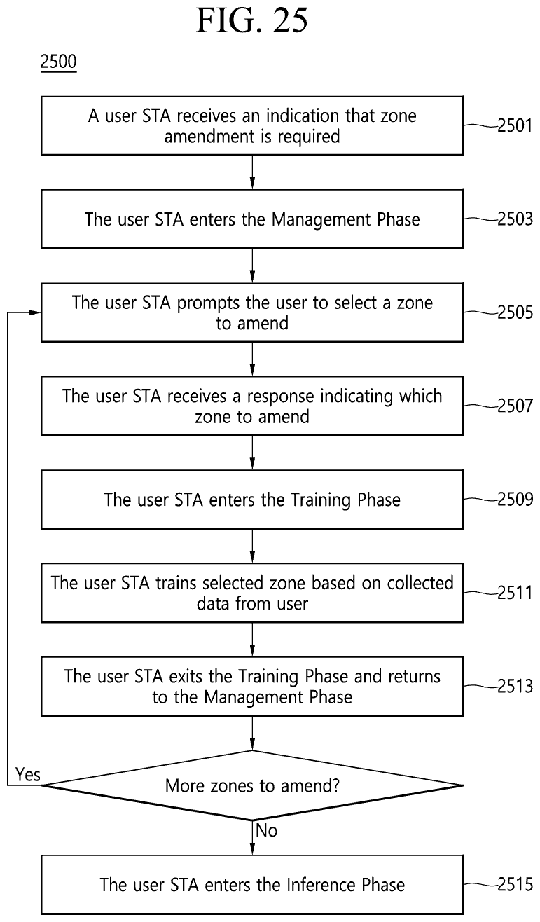

FIG. 25 shows a flowchart of the inputs and operations of a user STA corresponding to the process for amending zones in accordance with an embodiment.

Referring to FIG. 25, zone amendment, process 2500, begins at operation 2501. In operation 2501, a user STA receives, from a user, an indication that zone amendment is required.

In operation 2503, the user STA enters the Management Phase.

In operation 2505, the user STA prompts the user to select a zone to amend.

In operation 2507, the user STA receives, from the user, a response indicating which zone to amend.

In operation 2509, the user STA enters the Training Phase.

In operation 2511, the user STA trains the selected zone based on the range data and sensor data collected from the user during the Training Phase. The user STA training the selected zone involves updating the zone signatures based on the collected range data and sensor data.

In operation 2513, the user STA exits the Training Phase and returns to the Management Phase. Operation 2513 is followed by operation 2505 if the user indicates that there are more zones to amend. Operation 2513 is followed by operation 2515 if the user indicates that there are no more zones to amend.

In operation 2515, the user STA enters the Inference Phase.

The user STA may initialize a tracking filter. The user STA initializes a tracking filter through the positioning algorithm used to estimate the user's trajectory when walking, whether during the Training Phase or during the Inference Phase, by running the tracking filter within the Bayesian framework. This tracking filter needs to be initialized with an accurate position estimate. Therefore, the algorithm used by the user STA describes initializing this tracking filter upon receiving the very first set of ranges with the APs and re-initializing said filter while the filter is running in response to certain triggering events. Accordingly, the user STA may perform the following actions every estimation epoch k. The user STA ranges with APs and collects sensor readings since the last epoch. The user STA determines the current position \hat{x}ₖ of the device based on the output of the tracking filter with the inputs of the range measurements rₖ and sensor readings sₖ and returns it. Unless, if the user STA has performed the first estimation epoch/range measurement, determined the most recent position estimate \hat{x}ₖ₋₁ exceeds a threshold ƒₘₐₓ by the trilateration objective function ƒ(·), or determines that the time since the last estimation epoch corresponding to 3 or more range measurements Tₖ₋₁^{B} exceeds Tₘₐₓ^{B}, then the user STA moves to the next step to initialize/re-initialize the tracking filter. Subsequently, the user STA finds the intersection points {\tilde{x}ᵢ} of all pairs of circles, each centered \hat{p}_{α}, the location of AP α in the virtual space, with a radius r_{α}. The user STA then evaluates the trilateration objective function ƒ(·), the residual, for all intersection points {\tilde{x}ᵢ}. Subsequently, the user STA initializes the tracking filter with the point \tilde{x}*ᵢ with the smallest residual and returns it.

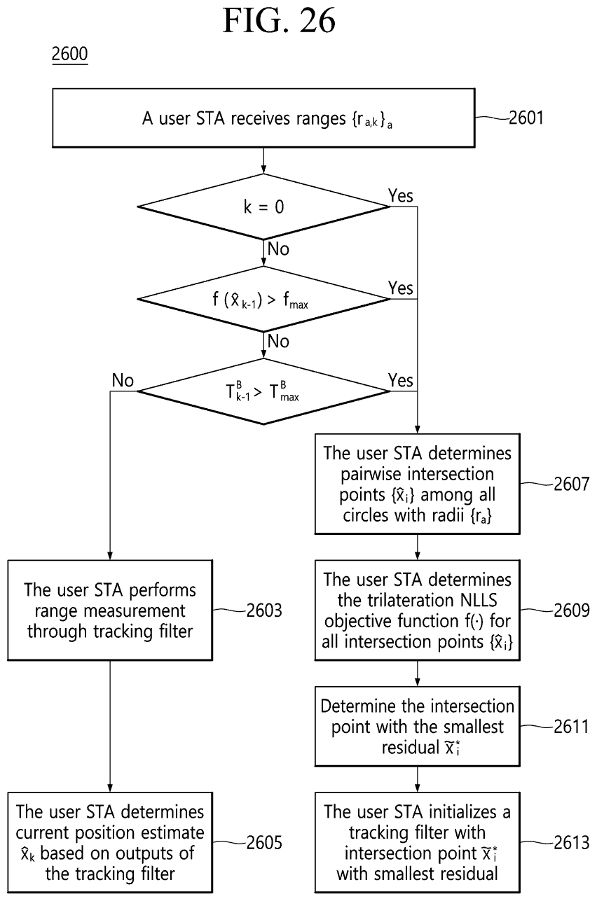

FIG. 26 shows a flowchart of the operations of a user STA corresponding to initialization and re-initialization of a positioning algorithm in accordance with an embodiment.

Referring to FIG. 26, the initialization and reinitialization process, process 2600, begins at 2601. In operation 2601, a user STA receives the ranges {r_{α,k}}_{α} from range with APs. Operation 2601 is followed by operation 2607 if the user STA receives the first estimation epoch/range measurement, represented as when k=0, if the most recent position estimate exceeds a threshold by the trilateration objective function, represented as ƒ(\hat{x}ₖ₋₁)>ƒₘₐₓ, or if the user STA determines that in the time since the last estimation epoch corresponding to 3 or more range measurements exceeds a threshold, represented as Tₖ₋₁^{B}>Tₘₐₓ^{B}. Operation 2601 is followed by operation 2603 if it's not the first estimation epoch/range measurement, the most recent position estimate doesn't exceed the threshold by the trilateration objective function and the user STA determines that Tₖ₋₁^{B} does not exceed Tₘₐₓ^{B}.

In operation 2603, the user STA performs range measurement through a tracking filter. The user STA may have already initialized a tracking filter.

In operation 2605, the user STA determines the current position estimate based on the tracking filter.

In operation 2607, the user STA determines pairwise intersection points {\hat{x}ᵢ} among all circles with radii {r_{α}}.

In operation 2609, the user STA determines a trilateration NLLS objective (residual) function ƒ(·) for all intersection points {\hat{x}ᵢ}.

In operation 2611, the user STA determines the intersection point with the smallest residual.

In operation 2613, the user STA initializes a tracking filter with intersection point with the smallest residual \tilde{x}*ᵢ.

The user STA begins (re)-initialization if k is equal to 0, if ƒ(\hat{x}ₖ₋₁)>ƒₘₐₓ, or if Tₖ₋₁^{B}>Tₘₐₓ^{B}. Otherwise, the user STA determines the position estimates \hat{x}ₖ from the tracking filter based on the range measurement and returns the position estimate \hat{x}ₖ. The user STA's (re)-initialization begins with finding pairwise intersection points {\tilde{x}ᵢ} among all circles with radii {r_{α}}. Subsequently, the user STA evaluates the trilateration non-linear least squares (NLLS) objective (residual) ƒ(·) for all intersection points. The user STA initializes the tracking filter with the intersection point \tilde{x}*ᵢ with the smallest residual and returns it.

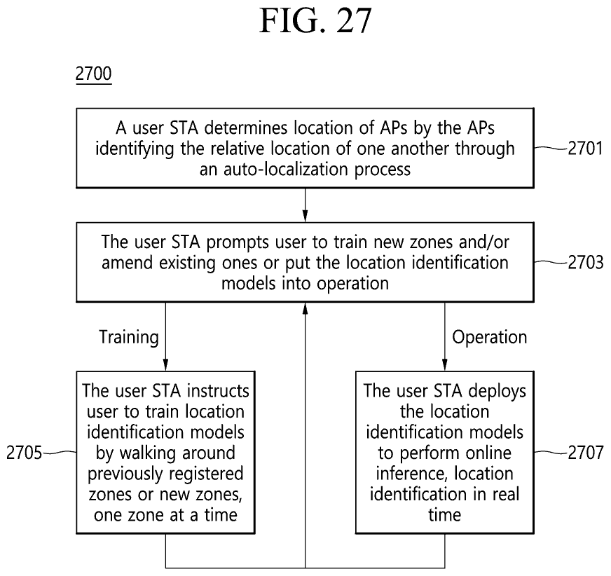

FIG. 27 shows a flowchart of the operations of a user STA user STA in accordance with an embodiment.

The process 2700 may begin in operation 2701. In operation 2701, the user STA determines the location of APs by the APs identifying the relative location of one another through an auto-localization process.

In operation 2703, the user STA prompts user to train new zones and/or amend existing ones or put location identification models into operation.

In operation 2705, the user STA instructs the user to train location identification models by walking around previously registered zones or new zones, one zone at a time if user chose training.

In operation 2707, the user STA deploys the location identification models to perform online inference, location identification in real time if user chose operation.

After either operation 2705 or 2707, the user STA will return to operation 2703.

The disclosure provides for location identification of target devices without the need for information from the target device associated with a floor plan of the premises, placement of zones or the locations of the anchor points.

According to various embodiments, a first STA requests, from an AP, a resource on behalf of a second STA so that AP will be able to efficiently allocate time (or TXOP) of the pending traffic from the first STA to the second or from the second STA to the first STA in their P2P communication, so that latency sensitive traffic may be delivered in a timely manner.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to cause:
receiving, from a target STA, information associated with a first anchor point (AP) and location identification model training;
transmitting, to the first AP, a first request that the first AP perform a first ranging with two or more other APs;
receiving, from the first AP, first ranging data that include location information for the first AP in response to the first request;
determining a location of the first AP based on the first ranging data;
training a first location identification model based on the information associated with location identification model training and the location of the first AP;
transmitting, to the first AP, a second request that the first AP perform a second ranging with the target STA;
receiving, from the first AP, second ranging data that include first movement information of the target STA in response to the second request; and
determining a first predicted position for the target STA based on the second ranging data and the trained first location identification model.

2. The STA of claim 1, wherein the processor is further configured to cause:
receiving, from the target STA, information associated with a second AP;
transmitting, to the first AP and the second AP, the first request that the first AP and the second AP perform the first ranging with one another and one or more other APs;
receiving, from the first AP and the second AP, the first ranging data that include location information for the first AP and the second AP in response to the first request;
determining the location of the first AP and a location of the second AP based on the first ranging data;
transmitting, to the first AP and the second AP, the second request that the first AP and the second AP perform the second ranging with the target STA; and
receiving, from the first AP and the second AP, the second ranging data that includes the first movement information of the target STA in response to the second request.

3. The STA of claim 1, wherein the processor is further configured to cause:
transmitting, to the first AP, a third request that the first AP perform a third ranging;
receiving, from the first AP, third ranging data that includes second movement information of the target STA in response to the third request; and
determining a second predicted position for the target STA based on the third ranging data and the trained first location identification model.

4. The STA of claim 1, wherein the training the first location identification model comprises:
transmitting, to the target STA, a third request that the target STA move around in a first zone;
receiving, from the target STA, first sensory data that includes third movement information of the target STA's movement in response to the third request;
transmitting, to the first AP, a fourth request that the first AP perform a third ranging with the target STA during the STA's movement in the first zone;
receiving, from the first AP, third ranging data that includes second movement information of the target STA's movement in response to the third request; and
updating the first location identification model based on the third ranging data, the first sensory data and the first zone.

5. The STA of claim 4, wherein the training the first location identification model further comprises:
tracking a first trajectory of the movement of the target STA inside the first zone based on an initial position of the target STA inside the first zone, the third ranging data and the first sensory data; and
generating a first zone signature based on the first trajectory, wherein the first zone signature characterizes one or more predicted positions in the first zone.

6. The STA of claim 5, wherein the processor is further configured to cause:
transmitting, to the first AP, the second request that the first AP perform the second ranging with the target STA for a period of time;
determining the first predicted position for the target STA based on the second ranging data and the trained first location identification model;
determining if the first predicted position is characterized by the first zone signature;
determining if the first predicted position belongs to the first zone signature based on information associated with the first zone signature and information associated with a second zone signature,
wherein the second zone signature characterizes the first predicted position in a second zone; and
updating the trained first location identification model based on the first predicted position belonging to the first zone signature.

7. The STA of claim 5, wherein the tracking further comprises:
transmitting, to the first AP, the second request that the AP perform the second ranging with the target STA for a period of time or the fourth request that the first AP perform the third ranging with the target STA;
receiving, from the first AP, the second ranging data or the third ranging data based on the movement of the target STA during a first sub-period of time;
determining a first predicted intersection position based on the location of the first AP and a location of a second AP;
determining a first residual of the first predicted intersection position based on trilateration; and
initializing a first track filter based on the first intersection position, wherein the first residual is less than a second residual of a second intersection position,
wherein the first track filter is used to track the first trajectory of the movement of the target STA in the first zone.

8. The STA of claim 4, wherein the training the first location identification model further comprises:
updating a first classifier based on the third ranging data and the first sensory data,
wherein the first classifier characterizes one or more predicted positions to belong to the first zone,
wherein the first classifier indicates if the first predicted position belongs to the first zone.

9. The STA of claim 4, wherein the processor is further configured to cause:
transmitting, to the target STA, a fifth request for information indicating if the first zone needs to be updated or a second zone needs to be updated;
receiving, from the target STA, a first response indicating that the first zone needs to be updated or the second zone needs to be updated; and
updating the first zone or the second zone based on the information associated with location identification model training and the location of the first AP.

10. The STA of claim 1, wherein the processor is further configured to cause:
determining information associated with a first AP and location identification model training;
transmitting, to the first AP, the first request that the first AP perform a first ranging with two or more other APs;
receiving, from the first AP, the first ranging data that includes location information for the first AP in response to the first request;
determining a location of the first AP based on the first ranging data;
training a first location identification model based on the information associated with location identification model training and the location of the first AP;
transmitting, to the first AP, the second request that the first AP perform a second ranging with the STA;
receiving, from the first AP, second ranging data that includes the first movement information of the STA in response to the second request; and
determining a first predicted position for the STA based on the second ranging data and the trained first location identification model.

11. A station (STA) in a wireless network, comprising:
a memory; and
a processor coupled to the memory, the processor configured to cause:
determining information associated with a first anchor point (AP) and location identification model training;
transmitting, to a locator STA, a first request for a first predicted position of the STA, and the information associated with the first AP and location identification model training;
receiving, from the locator STA, a second request that the STA move in a first zone based on the information associated with location identification model training;
moving in the first zone based on the second request in response to the second request; and
receiving, from the locator STA, the first predicted position of the STA in response to the first request.

12. The target STA of claim 11, wherein the processor is further configured to cause:
determining information associated with a second AP; and
transmitting, to the locator STA, the first request including information associated with the second AP.

13. The target STA of claim 11, wherein the processor is further configured to cause:
receiving, from the locator STA, a third request for information indicating if the first zone needs to be updated;
transmitting, to the locator STA, a second response including information indicating that the first zone needs to be updated;
receiving, from the locator STA, a fourth request that the STA move in the first zone based on the information associated with location identification model training; and
moving in the first zone based on the information associated with location identification model training in response to the fourth request.

14. A method performed by a station (STA), the method comprising:
receiving, from a target STA, information associated with a first anchor point (AP) and location identification model training;
transmitting, to the first AP, a first request that the first AP perform a first ranging with two or more other APs;
receiving, from the first AP, first ranging data that include location information for the first AP in response to the first request;
determining a location of the first AP based on the first ranging data;
training a first location identification model based on the information associated with location identification model training and the location of the first AP;
transmitting, to the first AP, a second request that the first AP perform a second ranging with the target STA;
receiving, from the first AP, second ranging data that include first movement information of the target STA in response to the second request; and
determining a first predicted position for the target STA based on the second ranging data and the trained first location identification model.

15. The method of claim 14, further comprising:
receiving, from the target STA, information associated with a second AP;
transmitting, to the first AP and the second AP, the first request that the first AP and the second AP perform the first ranging with one another and one or more other APs;
receiving, from the first AP and the second AP, the first ranging data that include location information for the first AP and the second AP in response to the first request;
determining the location of the first AP and a location of the second AP based on the first ranging data;
transmitting, to the first AP and the second AP, the second request that the first AP and the second AP perform the second ranging with the target STA; and
receiving, from the first AP and the second AP, the second ranging data that includes the first movement information of the target STA in response to the second request.

16. The method of claim 14, further comprising:
transmitting, to the first AP, a third request that the first AP perform a third ranging;
receiving, from the first AP, third ranging data that includes second movement information of the target STA in response to the third request; and
determining a second predicted position for the target STA based on the third ranging data and the trained first location identification model.

17. The method of claim 14, wherein the training the first location identification model comprises:
transmitting, to the target STA, a third request that the target STA move around in a first zone;
receiving, from the target STA, first sensory data that includes third movement information of the target STA's movement in response to the third request;
transmitting, to the first AP, a fourth request that the first AP perform a third ranging with the target STA during the STA's movement in the first zone;
receiving, from the first AP, third ranging data that includes second movement information of the target STA's movement in response to the third request; and
updating the first location identification model based on the third ranging data, the first sensory data and the first zone.

18. The method of claim 17, wherein the training the first location identification model further comprises:
tracking a first trajectory of the movement of the target STA inside the first zone based on an initial position of the target STA inside the first zone, the third ranging data and the first sensory data; and
generating a first zone signature based on the first trajectory, wherein the first zone signature characterizes one or more predicted positions in the first zone.

19. The method of claim 18, wherein the tracking further comprises:
transmitting, to the first AP, the second request that the AP perform the second ranging with the target STA for a period of time or the fourth request that the first AP perform the third ranging with the target STA;
receiving, from the first AP, the second ranging data or the third ranging data based on the movement of the target STA during a first sub-period of time;
determining a first predicted intersection position based on the location of the first AP and a location of a second AP;
determining a first residual of the first predicted intersection position based on trilateration; and
initializing a first track filter based on the first intersection position, wherein the first residual is less than a second residual of a second intersection position,
wherein the first track filter is used to track the first trajectory of the movement of the target STA in the first zone.

20. The method of claim 17, further comprising:
transmitting, to the target STA, a fifth request for information indicating if the first zone needs to be updated or a second zone needs to be updated;
receiving, from the target STA, a first response indicating that the first zone needs to be updated or the second zone needs to be updated; and
updating the first zone or the second zone based on the information associated with location identification model training and the location of the first AP.
